(19) United States
(12) Patent Application Publication
(10) Pub. No.: US 2025/0192951 A1
(43) Pub. Date: Jun. 12, 2025

(54) SOUNDING REFERENCE SIGNALS FOR UPLINK TRANSMIT ANTENNAS

(71) Applicant: QUALCOMM Incorporated, San Diego, CA (US)

(72) Inventors: Yi HUANG, San Diego, CA (US); Peter GAAL, San Diego, CA (US); Yu ZHANG, San Diego, CA (US); Gokul SRIDHARAN, Sunnyvale, CA (US); Muhammad Sayed Khairy ABDELGHAFFAR, San Jose, CA (US); Hyojin LEE, San Diego, CA (US)

(21) Appl. No.: 18/935,151

(22) Filed: Nov. 1, 2024

Related U.S. Application Data
(60) Provisional application No. 63/608,781, filed on Dec. 11, 2023.

(51) Int. Cl. H04L 5/00; H04L 27/26; H04W 8/22

(52) U.S. Cl. CPC H04L 5/0051; H04L 27/2605; H04W 8/22

(57) ABSTRACT

Some examples of the techniques described herein may facilitate transmissions using three antenna ports. For instance, some of the approaches described herein may enable uplink sounding (e.g., sounding reference signal (SRS)) transmission using three transmit antenna ports. In some examples, a four-port SRS resource may be reused for three-port SRS transmission. In some examples, a two-port SRS resource and a one-port SRS resource may be utilized for a three-port SRS transmission. Several aspects of SRS improvements may be provided to support uplink transmissions with three antenna ports. For instance, a coherent or non-coherent uplink codebook may be specified to facilitate three-antenna-port codebook-based transmissions. Some of the approaches may manage uplink transmission power or SRS resource signaling. For example, some of the techniques may provide SRS port to cyclic shift mapping or SRS power control.

### CROSS REFERENCE

The present Application for Patent claims the benefit of U.S. Provisional Patent Application No. 63/608,781 by HUANG et al., entitled “SOUNDING REFERENCE SIGNALS FOR UPLINK TRANSMIT ANTENNAS,” filed Dec. 11, 2023, assigned to the assignee hereof, and expressly incorporated by reference herein.

### FIELD OF TECHNOLOGY

The following relates to wireless communications, including sounding reference signals for uplink transmit antennas.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

Some wireless communication devices communicate using multiple antennas, which may be utilized to increase spatial diversity and robustness for communicating via a wireless channel. In some approaches, signals transmitted via multiple antennas may be assigned to one or more antenna ports. The signals may be precoded using a codebook and transmitted using one or more time and frequency resources associated with the codebook. For example, a user equipment (UE) may precode one or more sounding reference signals (SRSs) for transmission to a network entity. In some approaches, an SRS resource for a codebook-based physical uplink shared channel (PUSCH) may be determined with X=1, 2, 4, or 8 SRS ports. The SRS resource may also correspond to a quantity of resource blocks and a quantity of symbols (e.g., orthogonal frequency division multiplexing (OFDM) symbols). X SRS ports may be mapped to Y=1, 2, or 4 combs in the resource blocks. A comb may establish a set of resource elements (e.g., alternating resource elements) in the resource block. In each comb, for example, an X/Y quantity of cyclic shift may be utilized. One cyclic shift may be assigned to one SRS port. Some wireless communications systems or protocols may be limited to certain quantities of SRS ports (e.g., X=1, 2, 4, or 8 SRS ports).

Some of the techniques described herein may facilitate transmissions using three antenna ports while avoiding additional resource specification. For instance, some of the approaches described herein may enable uplink sounding (e.g., SRS) transmission using three transmit antenna ports (e.g., in situations where quantities of SRS ports provided by a wireless communications systems exclude three SRS ports, such as where X=1, 2, 4, or 8 SRS ports are provided). In some examples, a four-port SRS resource may be reused for three-port SRS transmission. In some examples, a two-port SRS resource and a one-port SRS resource may be utilized for a three-port SRS transmission. Utilizing a four-port SRS resource, or a combination of a one-port SRS resource and a two-port SRS resource, for a three-port SRS transmission, for example, may allow for devices to be implemented with three antennas (e.g., instead of four antennas) or may allow for the provision of three-layer multi-input and multiple-output (MIMO) transmissions, which may allow for improved communication performance without the additional expense of implementing four antennas. Several aspects of SRS improvements may be provided to support uplink transmissions with three antenna ports. For instance, a coherent or non-coherent uplink codebook may be specified to facilitate three-antenna-port codebook-based transmissions. Some of the approaches may manage uplink transmission power or SRS resource signaling. For example, some of the techniques may provide SRS port to cyclic shift mapping or SRS power control.

A method by a UE is described. The method may include communicating information indicating three antenna ports for a transmission from the UE of one or more SRSs and transmitting, based on the information indicating the three antenna ports, the one or more SRSs via the three antenna ports using one or more SRS resources, each of the one or more SRS resources being associated with a quantity of one or more antenna ports other than three, where a power for SRS transmission may be distributed over the three antenna ports or the SRS transmission may be limited to three antennas.

A UE is described. The UE may include one or more memories storing processor executable code, and one or more processors coupled with the one or more memories. The one or more processors may be individually or collectively operable to execute the code to cause the UE to communicate information indicating three antenna ports for a transmission from the UE of one or more SRSs and transmit, based on the information indicating the three antenna ports, the one or more SRSs via the three antenna ports using one or more SRS resources, each of the one or more SRS resources being associated with a quantity of one or more antenna ports other than three, where a power for SRS transmission may be distributed over the three antenna ports or the SRS transmission may be limited to three antennas.

Another UE is described. The UE may include means for communicating information indicating three antenna ports for a transmission from the UE of one or more SRSs and means for transmitting, based on the information indicating the three antenna ports, the one or more SRSs via the three antenna ports using one or more SRS resources, each of the one or more SRS resources being associated with a quantity of one or more antenna ports other than three, where a power for SRS transmission may be distributed over the three antenna ports or the SRS transmission may be limited to three antennas.

A non-transitory computer-readable medium storing code is described. The code may include instructions executable by one or more processors to communicate information indicating three antenna ports for a transmission from the UE of one or more SRSs and transmit, based on the information indicating the three antenna ports, the one or more SRSs via the three antenna ports using one or more SRS resources, each of the one or more SRS resources being associated with a quantity of one or more antenna ports other than three, where a power for SRS transmission may be distributed over the three antenna ports or the SRS transmission may be limited to three antennas.

In some examples of the method, UEs, and non-transitory computer-readable medium described herein, transmitting the one or more SRSs may include operations, features, means, or instructions for transmitting the one or more SRSs via the three antenna ports included in a set of four antenna ports, where the one or more SRS resources may be associated with the set of four antenna ports.

In some examples of the method, UEs, and non-transitory computer-readable medium described herein, each of the three antenna ports included in the set of four antenna ports may be mapped to a set of resource elements in accordance with a respective cyclic shift and one cyclic shift associated with one of the set of four antenna ports may be unused or muted for the SRS transmission, and the one or more SRSs may be transmitted via the set of resource elements and the three antenna ports.

In some examples of the method, UEs, and non-transitory computer-readable medium described herein, each of the three antenna ports may be mapped to a comb offset in the set of resource elements with the respective cyclic shift and the one or more SRSs may be transmitted in accordance with the comb offset via the set of resource elements and the three antenna ports.

In some examples of the method, UEs, and non-transitory computer-readable medium described herein, a first antenna port of the three antenna ports may be mapped, in accordance with a first comb offset, to the set of resource elements and a second antenna port of the three antenna ports may be a mapped to a second comb offset in the set of resource elements, where the second comb offset may be different from the first comb offset, and the one or more SRSs may be transmitted in accordance with the first comb offset and the second comb offset via the set of resource elements and the three antenna ports.

Some examples of the method, UEs, and non-transitory computer-readable medium described herein may further include operations, features, means, or instructions for communicating the information indicating the three antenna ports includes receiving a message indicating a configuration of four antenna ports and the configuration may be associated with use of the three antenna ports.

In some examples of the method, UEs, and non-transitory computer-readable medium described herein, the power for the SRS transmission may be distributed evenly over the three antenna ports.

In some examples of the method, UEs, and non-transitory computer-readable medium described herein, transmitting the one or more SRSs may include operations, features, means, or instructions for transmitting the one or more SRSs via the three antenna ports including a first antenna port and a set of two antenna ports that includes a second antenna port and a third antenna port, where a first SRS resource of the one or more SRS resources may be associated with the first antenna port and a second SRS resource of the one or more SRS resources may be associated with the set of two antenna ports.

In some examples of the method, UEs, and non-transitory computer-readable medium described herein, the one or more SRSs may be transmitted via a first symbol associated with the first SRS resource using the first antenna port, and via a second symbol associated with the second SRS resource using the set of two antenna ports, where the second symbol may be different from the first symbol.

In some examples of the method, UEs, and non-transitory computer-readable medium described herein, the one or more SRSs may be transmitted via the first symbol associated with the first SRS resource using the first antenna port with a first transmit power, and via the second symbol associated with the second SRS resource using the set of two antenna ports and a second transmit power greater than the first transmit power.

In some examples of the method, UEs, and non-transitory computer-readable medium described herein, the second transmit power may be approximately double the first transmit power.

In some examples of the method, UEs, and non-transitory computer-readable medium described herein, the one or more SRSs may be transmitted via the first symbol associated with the first SRS resource using the first antenna port with a first transmit power, and via the second symbol associated with the second SRS resource using the set of two antenna ports and a second transmit power that may be approximately equal to the first transmit power.

In some examples of the method, UEs, and non-transitory computer-readable medium described herein, the one or more SRSs may be transmitted via a first comb offset, of a set of resource elements, associated with the first SRS resource using the first antenna port, and via a second comb offset, of the set of resource elements, associated with the second SRS resource using the set of two antenna ports, where the second comb offset may be different from the first comb offset.

In some examples of the method, UEs, and non-transitory computer-readable medium described herein, the one or more SRSs may be transmitted via a symbol of a set of resource elements in accordance with a comb offset, the one or more SRSs being transmitted via the first SRS resource using the first antenna port and the second SRS resource using the set of two antenna ports and the first antenna port and the set of two antenna ports may be mapped to the set of resource elements in accordance with a respective cyclic shift.

Some examples of the method, UEs, and non-transitory computer-readable medium described herein may further include operations, features, means, or instructions for communicating the information indicating the three antenna ports includes receiving an indication of a combination of a first antenna port and a set of two antenna ports that includes a second antenna port and a third antenna port.

Some examples of the method, UEs, and non-transitory computer-readable medium described herein may further include operations, features, means, or instructions for receiving information indicating a set of combinations of the first antenna port and the set of two antenna ports, where the combination may be included in the set of combinations of the first antenna port and the set of two antenna ports.

Some examples of the method, UEs, and non-transitory computer-readable medium described herein may further include operations, features, means, or instructions for communicating the information indicating the three antenna ports includes transmitting a capability indication of the UE to transmit the SRSs via the three antenna ports or the three antennas.

A method for wireless communications by a network entity is described. The method may include communicating information indicating three antenna ports for a transmission from a UE of one or more SRSs and obtaining, based on the information indicating the three antenna ports, the one or more SRSs via the three antenna ports using one or more SRS resources, each of the one or more SRS resources being associated with a quantity of one or more antenna ports other than three, where a power for SRS transmission may be distributed over the three antenna ports or the SRS transmission may be limited to three antennas.

A network entity for wireless communications is described. The network entity may include one or more memories storing processor executable code, and one or more processors coupled with the one or more memories. The one or more processors may be individually or collectively operable to execute the code to cause the network entity to communicate information indicating three antenna ports for a transmission from a UE of one or more SRSs and obtain, based on the information indicating the three antenna ports, the one or more SRSs via the three antenna ports using one or more SRS resources, each of the one or more SRS resources being associated with a quantity of one or more antenna ports other than three, where a power for SRS transmission may be distributed over the three antenna ports or the SRS transmission may be limited to three antennas.

Another network entity for wireless communications is described. The network entity may include means for communicating information indicating three antenna ports for a transmission from a UE of one or more SRSs and means for obtaining, based on the information indicating the three antenna ports, the one or more SRSs via the three antenna ports using one or more SRS resources, each of the one or more SRS resources being associated with a quantity of one or more antenna ports other than three, where a power for SRS transmission may be distributed over the three antenna ports or the SRS transmission may be limited to three antennas.

A non-transitory computer-readable medium storing code for wireless communications is described. The code may include instructions executable by one or more processors to communicate information indicating three antenna ports for a transmission from a UE of one or more SRSs and obtain, based on the information indicating the three antenna ports, the one or more SRSs via the three antenna ports using one or more SRS resources, each of the one or more SRS resources being associated with a quantity of one or more antenna ports other than three, where a power for SRS transmission may be distributed over the three antenna ports or the SRS transmission may be limited to three antennas.

In some examples of the method, network entities, and non-transitory computer-readable medium described herein, obtaining the one or more SRSs may include operations, features, means, or instructions for obtaining the one or more SRSs via the three antenna ports included in a set of four antenna ports, where the one or more SRS resources may be associated with the set of four antenna ports.

In some examples of the method, network entities, and non-transitory computer-readable medium described herein, the one or more SRSs may be obtained in accordance with a respective cyclic shift corresponding to each of the three antenna ports included in the set of four antenna ports and one cyclic shift associated with one of the set of four antenna ports may be unused or muted for the SRS transmission from the UE.

Some examples of the method, network entities, and non-transitory computer-readable medium described herein may further include operations, features, means, or instructions for outputting a message to a second UE for configuring the second UE with the one cyclic shift that may be unused for the SRS transmission from the UE.

In some examples of the method, network entities, and non-transitory computer-readable medium described herein, the one or more SRSs may be obtained in accordance with a comb offset in a set of resource elements corresponding to each of the three antenna ports.

In some examples of the method, network entities, and non-transitory computer-readable medium described herein, the one or more SRSs may be obtained via a first antenna port of the three antenna ports in accordance with a first comb offset in a set of resource elements and via a second antenna port of the three antenna ports in accordance with a second comb offset in the set of resource elements, where the second comb offset may be different from the first comb offset.

Some examples of the method, network entities, and non-transitory computer-readable medium described herein may further include operations, features, means, or instructions for communicating the information indicating the three antenna ports includes outputting a message indicating a configuration of four antenna ports and the configuration may be associated with use of the three antenna ports.

In some examples of the method, network entities, and non-transitory computer-readable medium described herein, the power for the SRS transmission may be distributed evenly over the three antenna ports.

In some examples of the method, network entities, and non-transitory computer-readable medium described herein, obtaining the one or more SRSs may include operations, features, means, or instructions for obtaining the one or more SRSs via the three antenna ports including a first antenna port and a set of two antenna ports that includes a second antenna port and a third antenna port, where a first SRS resource of the one or more SRS resources may be associated with the first antenna port and a second SRS resource of the one or more SRS resources may be associated with the set of two antenna ports.

In some examples of the method, network entities, and non-transitory computer-readable medium described herein, the one or more SRSs may be received via a first symbol associated with the first SRS resource and the first antenna port, and via a second symbol associated with the second SRS resource and the set of two antenna ports, where the second symbol may be different from the first symbol.

In some examples of the method, network entities, and non-transitory computer-readable medium described herein, the one or more SRSs may be received via the first symbol associated with the first SRS resource and the first antenna port with a first transmit power, and via the second symbol associated with the second SRS resource, the set of two antenna ports, and a second transmit power greater than the first transmit power.

In some examples of the method, network entities, and non-transitory computer-readable medium described herein, the second transmit power may be approximately double the first transmit power.

Some examples of the method, network entities, and non-transitory computer-readable medium described herein may further include operations, features, means, or instructions for measuring at least one of the one or more SRSs that may be obtained via the first symbol associated with the first SRS resource and the first antenna port to generate a first measurement, measuring at least one of the one or more SRSs that may be obtained via the second symbol associated with the second SRS resource and the set of two antenna ports to generate a second measurement, and increasing the second measurement relative to the first measurement.

In some examples of the method, network entities, and non-transitory computer-readable medium described herein, the one or more SRSs may be obtained via a first comb offset, of a set of resource elements, associated with the first SRS resource and the first antenna port, and via a second comb offset, of the set of resource elements, associated with the second SRS resource and the set of two antenna ports, where the second comb offset may be different from the first comb offset.

In some examples of the method, network entities, and non-transitory computer-readable medium described herein, the one or more SRSs may be obtained via a symbol of a set of resource elements in accordance with a comb offset, the one or more SRSs being obtained via the first SRS resource, the first antenna port, the second SRS resource, and the set of two antenna ports and the first antenna port and the set of two antenna ports may be mapped to the set of resource elements in accordance with a respective cyclic shift.

Some examples of the method, network entities, and non-transitory computer-readable medium described herein may further include operations, features, means, or instructions for communicating the information indicating the three antenna ports includes outputting an indication of a combination of a first antenna port and a set of two antenna ports that includes a second antenna port and a third antenna port.

Some examples of the method, network entities, and non-transitory computer-readable medium described herein may further include operations, features, means, or instructions for outputting information indicating a set of combinations of the first antenna port and the set of two antenna ports, where the combination may be included in the set of combinations of the first antenna port and the set of two antenna ports.

Some examples of the method, network entities, and non-transitory computer-readable medium described herein may further include operations, features, means, or instructions for communicating the information indicating the three antenna ports includes receiving a capability indication of the UE to transmit the SRSs via the three antenna ports or the three antennas.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects and embodiments are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, embodiments and/or uses may come about via integrated chip embodiments and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described embodiments. For example, transmission and reception of wireless signals necessarily includes a number of components for analog and digital purposes (e.g., hardware components including antenna, radio frequency (RF)-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

### BRIEF DESCRIPTION OF THE DRAWINGS

FIG. 1 shows an example of a wireless communications system that supports sounding reference signals (SRSs) for uplink transmit antennas in accordance with one or more aspects of the present disclosure.

FIG. 2 shows an example of a network architecture that supports SRSs for uplink transmit antennas in accordance with one or more aspects of the present disclosure.

FIG. 3 shows an example of a wireless communications system that supports SRSs for uplink transmit antennas in accordance with one or more aspects of the present disclosure.

FIG. 4 shows an example of a first scenario and an example of a second scenario that support SRSs for uplink transmit antennas in accordance with one or more aspects of the present disclosure.

FIG. 5 shows an example of time domain combining, an example of comb domain combining, and an example of cyclic shift domain combining that support SRSs for uplink transmit antennas in accordance with one or more aspects of the present disclosure.

FIG. 6 shows an example of a process flow that supports SRSs for uplink transmit antennas in accordance with one or more aspects of the present disclosure.

FIGS. 7 and 8 show block diagrams of devices that support SRSs for uplink transmit antennas in accordance with one or more aspects of the present disclosure.

FIG. 9 shows a block diagram of a communications manager that supports SRSs for uplink transmit antennas in accordance with one or more aspects of the present disclosure.

FIG. 10 shows a diagram of a system including a device that supports SRSs for uplink transmit antennas in accordance with one or more aspects of the present disclosure.

FIGS. 11 and 12 show block diagrams of devices that support SRSs for uplink transmit antennas in accordance with one or more aspects of the present disclosure.

FIG. 13 shows a block diagram of a communications manager that supports SRSs for uplink transmit antennas in accordance with one or more aspects of the present disclosure.

FIG. 14 shows a diagram of a system including a device that supports SRSs for uplink transmit antennas in accordance with one or more aspects of the present disclosure.

FIGS. 15 through 18 show flowcharts illustrating methods that support SRSs for uplink transmit antennas in accordance with one or more aspects of the present disclosure.

### DETAILED DESCRIPTION

Some wireless communication devices communicate using multiple antennas, which may be utilized to increase spatial diversity and robustness for communicating via a wireless channel. In some approaches, signals transmitted via multiple antennas may be assigned to one or more antenna ports. The signals may be precoded using a codebook and transmitted using one or more time and frequency resources associated with the codebook. For example, a user equipment (UE) may precode one or more sounding reference signals (SRSs) for transmission to a network entity. In some approaches, an SRS resource for a codebook-based physical uplink shared channel (PUSCH) may be determined with X=1, 2, 4, or 8 SRS ports (which may follow an exponential pattern, for instance). The SRS resource may also correspond to a quantity of resource blocks and a quantity of symbols (e.g., orthogonal frequency division multiplexing (OFDM) symbols). X SRS ports may be mapped to Y=1, 2, or 4 combs in the resource blocks. A comb may establish a set of resource elements (e.g., alternating resource elements) in the resource block. In each comb, for example, an X/Y quantity of cyclic shift may be utilized. One cyclic shift may be assigned to one SRS port. Some approaches may not allow an SRS resource to be associated with three ports. Because additional antenna ports may incur additional cost, limiting antenna ports to one, two, four, or eight ports may forego an opportunity to provide increased performance with three antenna ports while avoiding some of the cost associated with four or more antenna ports. For example, a UE may be limited to three antennas (e.g., may only include three antennas) for communications via a cellular network (e.g., wireless wide area network (WWAN)), which may save the cost of one or more additional antennas or other supporting circuitry (e.g., power amplifier(s) (PA(s)), filter(s), switch(es), or radio frequency front-end (RFFE) circuitry, among other examples). Some of the techniques described herein (e.g., utilizing a four-port SRS resource with an unused or muted port, or a combination of a one-port SRS resource and a two-port SRS resource, for a three-port SRS transmission) may allow for devices to be implemented with three antennas (e.g., instead of four antennas) or may allow for the provision of three-layer multi-input and multiple-output (MIMO) transmissions, which may allow for improved communication performance without the additional expense of implementing four antennas, without the additional complexity of circuitry to support four antennas, or without the additional power consumption to operate four antennas (e.g., without following an exponential pattern for quantities of antennas or antenna ports). Additionally, or alternatively, some of the techniques described herein may allow for interoperability of a device with a wireless communications system that specifies a limitation on quantities of SRS ports that may be utilized (e.g., a wireless communications system that does not specify, provide, or configure, an SRS resource with three ports). For instance, the use of three ports may be enabled in accordance with some of the techniques described herein for a wireless communications system that does not configure SRS resources specifically for three ports.

Some of the techniques described herein may facilitate transmissions using three antenna ports while avoiding additional resource specification. For instance, some of the approaches described herein may enable uplink sounding (e.g., SRS) transmission using three transmit antenna ports and three antennas. In some examples, a four-port SRS resource may be reused for three-port SRS transmission. Utilizing a four-port SRS resource for a three-port SRS transmission may leave one SRS port unused or muted (which may sacrifice the use of one SRS port to allow for a three-port SRS transmission in some cases, for instance). In some examples, a two-port SRS resource and a one-port SRS resource may be utilized for a three-port SRS transmission. For instance, the three-port SRS transmission may be mapped to three antennas (e.g., only three antennas) for transmission. Several aspects of SRS improvements may be provided to support uplink transmissions with three antenna ports. For instance, a coherent or non-coherent uplink codebook may be specified to facilitate three-antenna-port codebook-based transmissions. Some of the approaches may manage uplink transmission power or SRS resource signaling. For example, some of the techniques may provide SRS port to cyclic shift mapping or SRS power control.

Aspects of the disclosure are initially described in the context of wireless communications systems. Aspects of the disclosure are further illustrated by and described with reference to diagrams illustrating examples of scenarios relating to SRS for uplink transmit antennas. Aspects of the disclosure are further illustrated by and described with reference to diagrams illustrating examples of combining relating to SRS for uplink transmit antennas. Aspects of the disclosure are further illustrated by and described with reference to a process flow diagram. Aspects of the disclosure are further illustrated by and described with reference to apparatus diagrams, system diagrams, and flowcharts that relate to SRSs for uplink transmit antennas.

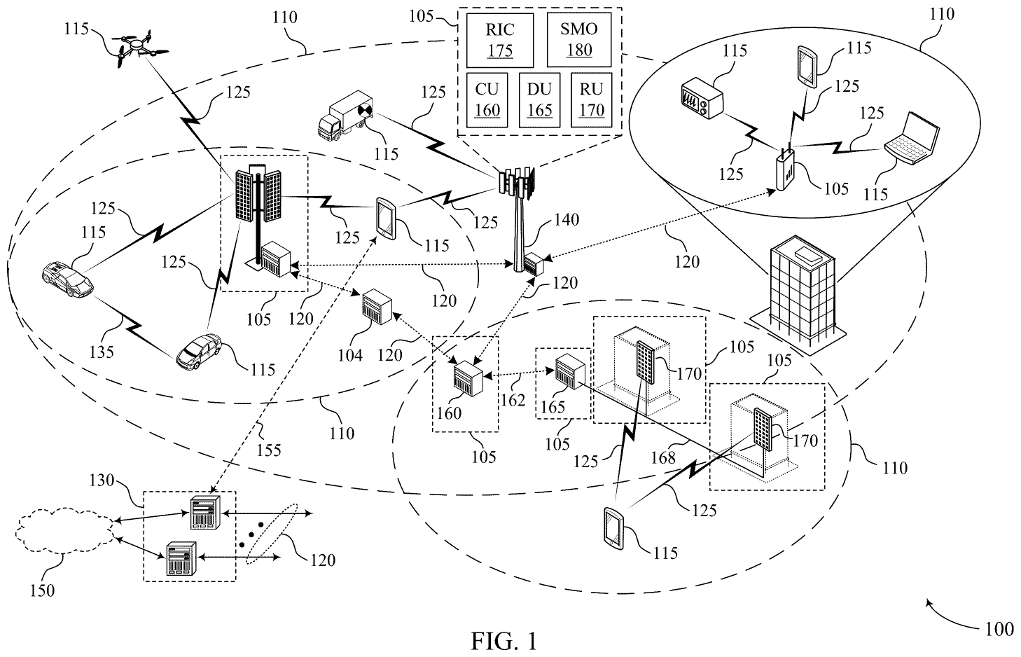

FIG. 1 shows an example of a wireless communications system 100 that supports SRSs for uplink transmit antennas in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support SRSs for uplink transmit antennas as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas (e.g., two, three, four, or more antennas), which may be used to employ techniques such as transmit diversity, receive diversity, MIMO communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

Some wireless communication devices communicate using multiple antennas (e.g., two, three, four, or more antennas), which may be utilized to increase spatial diversity and robustness for communicating via a wireless channel. In some approaches, signals transmitted via multiple antennas may be assigned to one or more antenna ports. The signals may be precoded using a codebook and transmitted using one or more time and frequency resources associated with the codebook. For example, a UE 115 may precode one or more SRSs for transmission to a network entity 105. In some approaches, an SRS resource for a codebook-based physical uplink shared channel (PUSCH) (e.g., one or more SRS resources for one or more codebook-based PUSCHs) may be determined with X=1, 2, 4, or 8 SRS ports. The SRS resource may also correspond to a quantity of resource blocks or a quantity of symbols (e.g., OFDM symbols). X SRS ports may be mapped to Y=1, 2, or 4 combs in the resource blocks. A comb may establish a set of resource elements (e.g., alternating resource elements) in the resource block. In each comb, for example, an X/Y quantity of cyclic shift may be utilized. One cyclic shift may be assigned to one SRS port. Some approaches may not allow an SRS resource to be associated with three ports. Because additional antenna ports may incur additional cost, limiting antenna ports to one, two, four, or eight ports may forego an opportunity to provide increased performance with three antenna ports while avoiding some of the cost associated with four or more antenna ports. For example, a UE 115 may be limited to three antennas (e.g., may only include three antennas) for communications via a cellular network (e.g., WWAN), which may save the cost of one or more additional antennas or other supporting circuitry (e.g., PA(s), filter(s), switch(es), or RFFE circuitry, among other examples). In some cases, a UE may include one or more other antennas for communication with one or more other radio access technologies (RATs).

Some of the techniques described herein may facilitate transmissions using three antenna ports (e.g., only three antennas) while avoiding additional resource specification. For instance, some of the approaches described herein may enable uplink sounding (e.g., SRS) transmission using three transmit antenna ports and three antennas without configuring or allocating SRS resources for exactly three antennas. In some examples, a UE 115 may utilize a four-port SRS resource for three-port SRS transmission. In some examples, a UE 115 may utilize a two-port SRS resource and a one-port SRS resource for a three-port SRS transmission. Several aspects of SRS improvements may be provided to support uplink transmissions with three antenna ports. For instance, a coherent or non-coherent uplink codebook may be specified to facilitate three-antenna-port codebook-based transmissions. Some of the approaches may manage uplink transmission power or SRS resource signaling. For example, some of the techniques may provide SRS port to cyclic shift mapping or SRS power control.

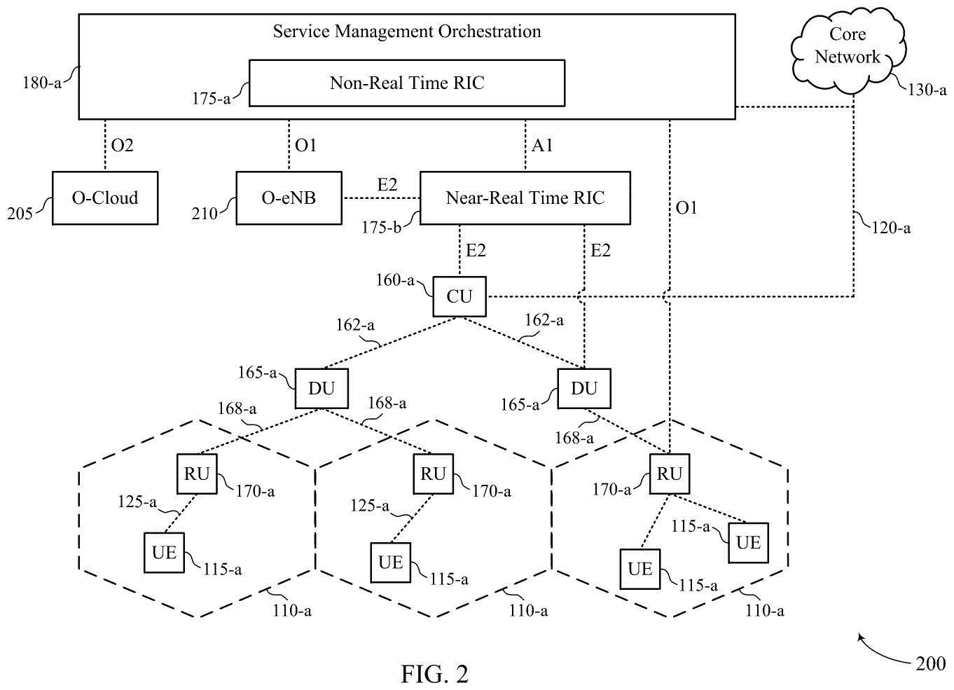

FIG. 2 shows an example of a network architecture 200 (e.g., a disaggregated base station architecture, a disaggregated RAN architecture) that supports SRSs for uplink transmit antennas in accordance with one or more aspects of the present disclosure. The network architecture 200 may illustrate an example for implementing one or more aspects of the wireless communications system 100. The network architecture 200 may include one or more CUs 160-a that may communicate directly with a core network 130-a via a backhaul communication link 120-a, or indirectly with the core network 130-a through one or more disaggregated network entities 105 (e.g., a Near-RT RIC 175-b via an E2 link, or a Non-RT RIC 175-a associated with an SMO 180-a (e.g., an SMO Framework), or both). A CU 160-a may communicate with one or more DUs 165-a via respective midhaul communication links 162-a (e.g., an F1 interface). The DUs 165-a may communicate with one or more RUs 170-a via respective fronthaul communication links 168-a. The RUs 170-a may be associated with respective coverage areas 110-a and may communicate with UEs 115-a via one or more communication links 125-a. In some implementations, a UE 115-a may be simultaneously served by multiple RUs 170-a.

Each of the network entities 105 of the network architecture 200 (e.g., CUs 160-a, DUs 165-a, RUs 170-a, Non-RT RICs 175-a, Near-RT RICs 175-b, SMOs 180-a, Open Clouds (O-Clouds) 205, Open eNBs (O-eNBs) 210) may include one or more interfaces or may be coupled with one or more interfaces configured to receive or transmit signals (e.g., data, information) via a wired or wireless transmission medium. Each network entity 105, or an associated processor (e.g., controller) providing instructions to an interface of the network entity 105, may be configured to communicate with one or more of the other network entities 105 via the transmission medium. For example, the network entities 105 may include a wired interface configured to receive or transmit signals over a wired transmission medium to one or more of the other network entities 105. Additionally, or alternatively, the network entities 105 may include a wireless interface, which may include a receiver, a transmitter, or transceiver (e.g., an RF transceiver) configured to receive or transmit signals, or both, over a wireless transmission medium to one or more of the other network entities 105.

In some examples, a CU 160-a may host one or more higher layer control functions. Such control functions may include RRC, PDCP, SDAP, or the like. Each control function may be implemented with an interface configured to communicate signals with other control functions hosted by the CU 160-a. A CU 160-a may be configured to handle user plane functionality (e.g., CU-UP), control plane functionality (e.g., CU-CP), or a combination thereof. In some examples, a CU 160-a may be logically split into one or more CU-UP units and one or more CU-CP units. A CU-UP unit may communicate bidirectionally with the CU-CP unit via an interface, such as an E1 interface when implemented in an O-RAN configuration. A CU 160-a may be implemented to communicate with a DU 165-a, as necessary, for network control and signaling.

A DU 165-a may correspond to a logical unit that includes one or more functions (e.g., base station functions, RAN functions) to control the operation of one or more RUs 170-a. In some examples, a DU 165-a may host, at least partially, one or more of an RLC layer, a MAC layer, and one or more aspects of a PHY layer (e.g., a high PHY layer, such as modules for FEC encoding and decoding, scrambling, modulation and demodulation, or the like) depending, at least in part, on a functional split, such as those defined by the 3rd Generation Partnership Project (3GPP). In some examples, a DU 165-a may further host one or more low PHY layers. Each layer may be implemented with an interface configured to communicate signals with other layers hosted by the DU 165-a, or with control functions hosted by a CU 160-a.

In some examples, lower-layer functionality may be implemented by one or more RUs 170-a. For example, an RU 170-a, controlled by a DU 165-a, may correspond to a logical node that hosts RF processing functions, or low-PHY layer functions (e.g., performing fast Fourier transform (FFT), inverse FFT (iFFT), digital beamforming, physical random access channel (PRACH) extraction and filtering, or the like), or both, based at least in part on the functional split, such as a lower-layer functional split. In such an architecture, an RU 170-a may be implemented to handle over the air (OTA) communication with one or more UEs 115-a. In some implementations, real-time and non-real-time aspects of control and user plane communication with the RU(s) 170-a may be controlled by the corresponding DU 165-a. In some examples, such a configuration may enable a DU 165-a and a CU 160-a to be implemented in a cloud-based RAN architecture, such as a vRAN architecture.

The SMO 180-a may be configured to support RAN deployment and provisioning of non-virtualized and virtualized network entities 105. For non-virtualized network entities 105, the SMO 180-a may be configured to support the deployment of dedicated physical resources for RAN coverage requirements which may be managed via an operations and maintenance interface (e.g., an O1 interface). For virtualized network entities 105, the SMO 180-a may be configured to interact with a cloud computing platform (e.g., an O-Cloud 205) to perform network entity life cycle management (e.g., to instantiate virtualized network entities 105) via a cloud computing platform interface (e.g., an O2 interface). Such virtualized network entities 105 can include, but are not limited to, CUs 160-a, DUs 165-a, RUs 170-a, and Near-RT RICs 175-b. In some implementations, the SMO 180-a may communicate with components configured in accordance with a 4G RAN (e.g., via an O1 interface). Additionally, or alternatively, in some implementations, the SMO 180-a may communicate directly with one or more RUs 170-a via an O1 interface. The SMO 180-a also may include a Non-RT RIC 175-a configured to support functionality of the SMO 180-a.

The Non-RT RIC 175-a may be configured to include a logical function that enables non-real-time control and optimization of RAN elements and resources, Artificial Intelligence (AI) or Machine Learning (ML) workflows including model training and updates, or policy-based guidance of applications/features in the Near-RT RIC 175-b. The Non-RT RIC 175-a may be coupled to or communicate with (e.g., via an A1 interface) the Near-RT RIC 175-b. The Near-RT RIC 175-b may be configured to include a logical function that enables near-real-time control and optimization of RAN elements and resources via data collection and actions over an interface (e.g., via an E2 interface) connecting one or more CUs 160-a, one or more DUs 165-a, or both, as well as an O-eNB 210, with the Near-RT RIC 175-b.

In some examples, to generate AI/ML models to be deployed in the Near-RT RIC 175-b, the Non-RT RIC 175-a may receive parameters or external enrichment information from external servers. Such information may be utilized by the Near-RT RIC 175-b and may be received at the SMO 180-a or the Non-RT RIC 175-a from non-network data sources or from network functions. In some examples, the Non-RT RIC 175-a or the Near-RT RIC 175-b may be configured to tune RAN behavior or performance. For example, the Non-RT RIC 175-a may monitor long-term trends and patterns for performance and employ AI or ML models to perform corrective actions through the SMO 180-a (e.g., reconfiguration via O1) or via generation of RAN management policies (e.g., A1 policies).

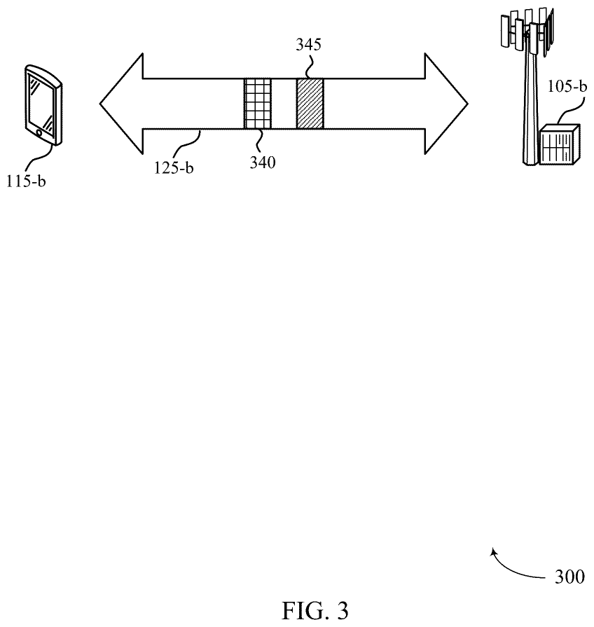

FIG. 3 shows an example of a wireless communications system 300 that supports SRSs for uplink transmit antennas in accordance with one or more aspects of the present disclosure. For instance, the wireless communications system 300 may include a UE 115-b and a network entity 105-b. In some aspects, the UE 115-b may be an example of a UE 115 as described with reference to FIG. 1 or a UE 115-a as described with reference to FIG. 2. In some aspects, the network entity 105-b may be an example of a network entity 105 as described with reference to FIG. 1 or may be an example of a CU 160-a, a DU 165-a, or an RU 170-a as described with reference to FIG. 2.

The UE 115-b may communicate with the network entity 105-b using a communication link 125-b, which may be an example of a communication link 125 described with reference to FIG. 1 or a communication link 125-a as described with reference to FIG. 2. The communication link 125-b may include a bi-directional link that enables both uplink and downlink network communications. For example, the UE 115-b may transmit one or more transmissions (e.g., uplink control signals or data signals), to the network entity 105-b using the communication link 125-b, and the network entity 105-b may transmit one or more transmissions (e.g., downlink control signals or data signals), to the UE 115-b using the communication link 125-b. In some examples, the communication link 125-b may include, may carry, or may be implemented via one or more channels (e.g., PDCCH, PDSCH, or PUSCH, among other examples).

The UE 115-b or the network entity 105-b may communicate information 340 indicating three antenna ports for a transmission from the UE 115-b of one or more SRSs. As used herein, the term “communicate” and variations thereof may denote output, transmission, reception, obtaining, or a combination thereof. For instance, the UE 115-b may transmit the information 340 to the network entity 105-b or may receive the information 340 from the network entity 105-b. In some examples, the information 340 may be a capability indication, a configuration, an indication of antenna ports to use, or a combination thereof. For instance, communicating the information 340 indicating the three antenna ports may include transmitting a capability indication of the UE 115-b to transmit the SRSs via the three antenna ports or the three antennas. In some approaches, the network entity 105-b may obtain (e.g., receive) the capability indication of the UE 115-b to transmit the SRSs via the three antenna ports or the three antennas. The network entity 105-b may, in response to obtaining the capability indication, output (e.g., transmit) a signal or message to configure the UE 115-b to operate using the three antenna ports (e.g., to transmit the SRSs via the three antenna ports or the three antennas). In some examples, an antenna port may refer to (or may be associated with) a channel for communication via one or more antennas. For instance, a first antenna port may be mapped to a first antenna (e.g., a first physical antenna), a second antenna port may be mapped to a second antenna (e.g., a second physical antenna), and a third antenna port may be mapped to a third antenna (e.g., a third physical antenna).

The UE 115-b may transmit, based on the information 340 indicating the three antenna ports, the one or more SRSs 345 via the three antenna ports (e.g., the three antennas) using one or more SRS resources. An SRS resource may include one or more time resources or frequency resources (e.g., a resource element (RE)) for communicating an SRS. For instance, an SRS resource may include one or more symbols (e.g., OFDM symbols) or subcarriers for communicating an SRS. Each of the one or more SRS resources may be associated with a quantity of one or more antenna ports other than three. For example, the one or more SRSs 345 may be communicated via three antenna ports, while the one or more SRS resources may be associated with one antenna port, two antenna ports, four antenna ports, another quantity of antenna ports other than three, or a combination thereof.

In some examples, the UE 115-b may be configured or assigned the one or more SRS resources associated with a quantity of one or more antenna ports other than three. For instance, the network entity 105-b may configure the UE 115-b with the one or more SRS resources periodically, semi-persistently, or aperiodically. In some approaches, the one or more SRS resources may be associated with four antenna ports or may be associated with a first antenna port and a set of two antenna ports that includes a second antenna port and a third antenna port. Other approaches may instead specify SRS resources for exactly three antenna ports or three antennas, which may increase configuration complexity.

In some aspects, a power for SRS transmission may be distributed over the three antenna ports. For instance, the UE 115-b may transmit the one or more SRSs via the three antenna ports (e.g., three antennas), where power for the SRS transmission is distributed evenly (e.g., approximately equally) over the three antenna ports or unevenly over the three antenna ports. Distributing power evenly for the SRS transmission over three antenna ports may provide layer transmissions with approximately a same power (which may reduce the complexity of channel estimation, for instance) per layer, while changing default power allocation from a four-port transmission or from a one-port and two-port transmissions, in some approaches. Accordingly, wireless communications systems that limit SRS resources to 1, 2, or 4 ports, or more, may adjust power distribution to provide even power distribution over three ports. In some examples, the SRS transmission may be limited to three antennas. For instance, the UE 115-b may include three antennas (e.g., only three antennas) for the SRS transmission or for cellular (e.g., WWAN) communications. In some approaches, the three antenna ports may be mapped (e.g., respectively mapped) to the three antennas. Additionally, or alternatively, the UE 115-b may include supporting circuitry (e.g., PA(s), filter(s), switch(es), or RFFE circuitry) for cellular communication for the three antennas (e.g., for only the three antennas). In some aspects, the UE 115-b may include one or more other antennas or supporting circuitry for one or more other RATs (e.g., for wireless local area network (WLAN) or Wi-Fi communications, or for personal area network (PAN) or Bluetooth communications, among other examples). In some examples, the UE 115-b may be limited to a total of three antennas for all RAT(s). For instance, the three antennas may be shared for communications among multiple RATs. The network entity 105-b may obtain (e.g., receive) the one or more SRSs via the three antenna ports (e.g., the three antennas) using the one or more SRS resources, where each of the one or more SRS resources is associated with a quantity of one or more antenna ports other than three. For instance, the SRS transmission may be limited to three antennas. The network entity 105-b may receive the SRS transmission utilizing the same or a different quantity (e.g., one, two, three, four, eight, or another quantity) of antennas.

In some approaches, the UE 115-b may transmit (or the network entity 105-b may obtain or receive) the one or more SRSs 345 via the three antenna ports included in a set of four antenna ports. The one or more SRS resources may be associated with the set of four antenna ports. For example, the UE 115-b may use an established (e.g., configured, assigned, or determined) four-port SRS to transmit a three-port SRS. For instance, the UE 115-b may reuse a four-port SRS resource for a three-port SRS transmission. In some examples, four may be a quantity of the antenna ports associated with one or more SRS resources. Additionally, or alternatively, a set of four antenna ports may be included in a quantity (or quantities) of antenna ports or may be associated with one or more SRS resources. Additionally, or alternatively, the set of four antenna ports may correspond to the quantity of antenna ports or may be associated with one or more SRS resources. For instance, an SRS resource (or SRS resources) may be associated with a quantity of four antenna ports or may be associated with a set of four antenna ports (e.g., where four may be the quantity of antenna ports in the set of four antenna ports). In some approaches, one or more SRS resources may be configured or allocated for four antenna ports.

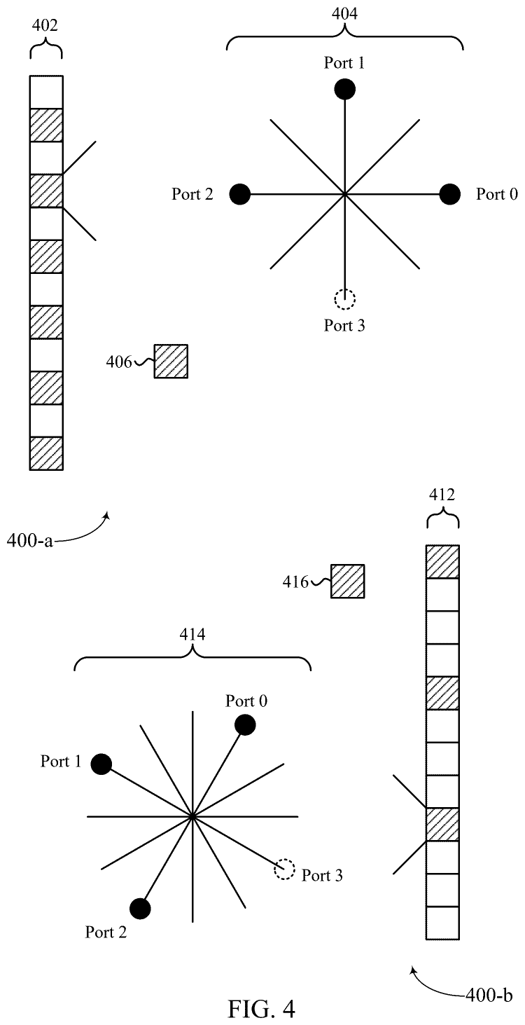

One or more antenna ports may be mapped to one or more SRS resources in accordance with one or more cyclic shifts. For example, each of the three antenna ports included in the set of four antenna ports may be mapped to a set of resource elements in accordance with a respective cyclic shift. One cyclic shift associated with one of the set of four antenna ports may be unused for the SRS transmission, and the one or more SRSs 345 may be transmitted via the set of resource elements and the three antenna ports. For example, one antenna port or one cyclic shift may be unused (e.g., muted). In some approaches, the unused or muted antenna port may be a last antenna port (e.g., the fourth antenna port) or another antenna port (e.g., a specified antenna port, an antenna port indicated through configuration signaling from the network entity 105-b to the UE 115-b, or antenna port selected by or indicated in signaling from the UE 115-b to the network entity 105-b). Examples of unused (e.g., muted) antenna ports (e.g., unused or muted last antenna ports) are given with reference to FIG. 4. The network entity 105-b may obtain the one or more SRSs 345 in accordance with the respective cyclic shift corresponding to each of the three antenna ports included in the set of four antenna ports, where one cyclic shift associated with one of the set of four antenna ports is unused or muted for the SRS transmission from the UE 115-b.

In some examples, the network entity 105-b may output (e.g., transmit) a message to a second UE (not shown in FIG. 3) for configuring the second UE with the one cyclic shift that is unused for the SRS transmission from the UE 115-b. On the network side, for instance, the network may assign the cyclic shift of the unused antenna port to a second UE for a one-port SRS transmission, which may avoid wasting the SRS resource.

In some approaches, one or more SRS resources may be arranged in accordance with a comb structure. For instance, a “comb” may arrange an SRS resource to alternating or separated resource elements (e.g., subcarriers in a resource block). Examples of combs are provided with reference to FIG. 4. In some aspects, one or more antenna ports may be mapped to a comb offset or may be mapped in accordance with a comb offset. A comb offset may indicate a set of resource elements in the comb. For instance, a comb offset of 0 with a comb 2 may correspond to resource elements 0, 2, 4, 6, 8, and 10, or a comb offset of 1 with the 2-comb may correspond to resource elements 1, 3, 5, 7, 9, and 11.

In some examples, each of the three antenna ports may be mapped to a comb offset in the set of resource elements with the respective cyclic shift. Additionally, or alternatively, each of the three antenna port may be mapped, in accordance with a comb offset, to the set of resource elements. The one or more SRSs 345 may be transmitted in accordance with the comb offset via the set of resource elements and the three antenna ports. In some cases where the antenna ports are mapped to the same comb offset with different cyclic shifts, then one cyclic shift (e.g., the last cyclic shift or another cyclic shift) that maps to the unused antenna port, may not be used. The network entity 105-b may obtain (e.g., receive) the one or more SRSs in accordance with the comb offset in the set of resource elements corresponding to each of the three antenna ports.

In some aspects, a first antenna port of the three antenna ports may be mapped to a first comb offset in, or may be mapped in accordance with a comb offset to, the set of resource elements and a second antenna port of the three antenna ports may be mapped to a second different comb offset (e.g., a second comb offset that is different from the first comb offset) in the set of resource elements. The one or more SRSs 345 may be transmitted in accordance with the first comb offset and the second different comb offset via the set of resource elements and the three antenna ports. In some cases where antenna ports are mapped to two different comb offsets (e.g., in comb 4 or comb 8), one cyclic shift (e.g., the last cyclic shift or another cyclic shift) on the lower (or higher) comb offset may not be used. Examples of unused antenna ports are provided with reference to FIG. 4. The network entity 105-b may obtain (e.g., receive) the one or more SRSs 345 via a first antenna port of the three antenna ports in accordance with a first comb offset in a set of resource elements and via a second antenna port of the three antenna ports in accordance with a second different comb offset in the set of resource elements.

In some approaches, the power for the SRS transmission may be distributed evenly (e.g., approximately equally) over the three antenna ports. Some approaches may have a UE equally split power across configured SRS antenna ports (e.g., over four antenna ports) for the SRS resource. In accordance with some of the techniques described herein, where a four-port SRS resource is utilized (e.g., assigned, configured, or determined), the UE 115-b may split the power for the SRS transmission over the three antenna ports (e.g., SRS ports), rather than four SRS ports.

In some aspects, communicating the information 340 indicating the three antenna ports may include communicating (e.g., outputting, transmitting, or receiving) a message indicating a configuration of four antenna ports, where the configuration is associated with use of the three antenna ports. For instance, the network entity 105-b may output (e.g., transmit) or the UE 115-b may receive the information 340 (e.g., a configuration or assignment) indicating four antenna ports for transmitting the one or more SRSs 345. In some examples, the network entity 105-b may output (e.g., transmit) an indication for the use of three antenna ports for the SRS transmission, where three antenna ports of the indicated (e.g., configured or assigned) four antenna ports may be used for the actual SRS transmission. The indication for the use of three antenna ports may be an explicit indication (e.g., a bit explicitly indicating use of the three antenna ports) or may be an implicit indication (e.g., message timing, ordering, or arrangement indicating use of the three antenna ports).

In some examples of the techniques described herein, a two-port SRS resource and a one-port SRS resource may be utilized for a three-port SRS transmission. In some approaches, the UE 115-b may transmit (or the network entity 105-b may obtain or receive) the one or more SRSs 345 via the three antenna ports including a first antenna port and a set of two antenna ports that includes a second antenna port and a third antenna port. A first SRS resource of the one or more SRS resources may be associated with the first antenna port and a second SRS resource of the one or more SRS resources may be associated with the set of two antenna ports. The first antenna port (e.g., a one-port SRS resource) and the set of two antenna ports (e.g., a two-port SRS resource) may be combined in the time domain, in a comb domain, in a cyclic shift domain, or in a combination thereof. In some examples, one or two may be a quantity of the antenna ports associated with one or more SRS resources. Additionally, or alternatively, one antenna port or a set of two antenna ports may be included in a quantity (or quantities) of antenna ports or may be associated with one or more SRS resources. Additionally, or alternatively, one antenna port or the set of two antenna ports may correspond to the quantity (or quantities) of antenna ports or may be associated with one or more SRS resources. For instance, an SRS resource (or SRS resources) may be associated with a quantity of two antenna ports or may be associated with a set of two antenna ports (e.g., where two may be the quantity of antenna ports in the set of two antenna ports). In some approaches, one or more SRS resources may be configured or allocated for two antenna ports.

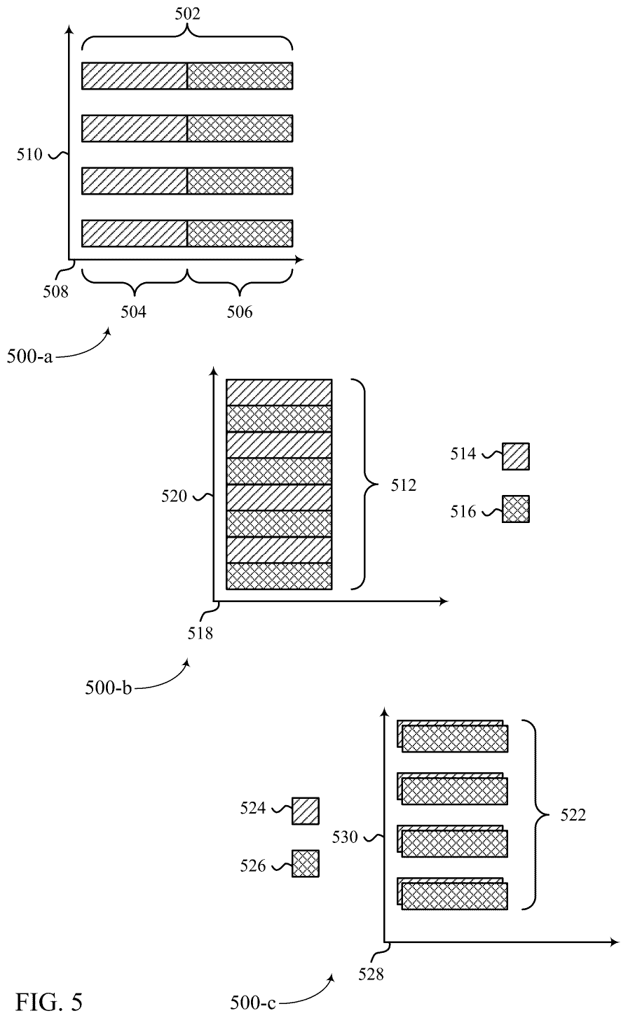

In time domain combining, for instance, the one or more SRSs 345 may be transmitted via a first symbol associated with the first SRS resource using the first antenna port, and via a second different symbol (e.g., a second symbol that is different from the first symbol) associated with the second SRS resource using the set of two antenna ports (e.g., the second antenna port and the third antenna port). An example of time domain combining is given with reference to FIG. 5. The network entity 105-b may obtain (e.g., receive) the one or more SRSs 345 via the first symbol associated with the first SRS resource and the first antenna port, and via the second different symbol associated with the second SRS resource and the set of two antenna ports.

Transmit power between the first symbol and the second symbol may be handled in accordance with one or more approaches. In time domain (e.g., time-division multiplexing) combining, the power for each symbol (e.g., SRS OFDM symbol) may be equal (e.g., approximately equal) or unequal.

In some examples, the one or more SRSs 345 may be transmitted via the first symbol associated with the first SRS resource using the first antenna port with a first transmit power, and via the second different symbol associated with the second SRS resource using the set of two antenna ports and a second transmit power greater than the first transmit power. The network entity 105-b may obtain (e.g., receive) the one or more SRSs 345 via the first symbol associated with the first SRS resource and the first antenna port with a first transmit power, and via the second different symbol associated with the second SRS resource, the set of two antenna ports, and a second transmit power greater than the first transmit power. The second transmit power may be approximately double the first transmit power in some approaches. For instance, the SRS transmit power on the two-port SRS symbol may be two times the power of the one-port SRS symbol to achieve equal power for each port.

In some examples, the one or more SRSs are transmitted via the first symbol associated with the first SRS resource using the first antenna port with a first transmit power, and via the second different symbol associated with the second SRS resource using the set of two antenna ports and a second transmit power that is approximately equal to the first transmit power.

In some approaches, where the first symbol and the second symbol use approximately equal power, the network entity 105-b may boost one of the symbols. For example, when two SRS OFDM symbols use same power, the network entity 105-b may artificially boost the signal-to-noise ratio (SNR) of the two-port SRS by 3 decibels (dB) to compensate for the power difference between the two SRS symbols. The network entity 105-b may measure at least one of the one or more SRSs 345 that are obtained via the first symbol associated with the first SRS resource and the first antenna port to generate a first measurement. The network entity 105-b may measure at least one of the one or more SRSs 345 that are obtained via the second different symbol associated with the second SRS resource and the set of two antenna ports to generate a second measurement, and may increase the second measurement relative to the first measurement.

In comb domain combining, the UE 115-b may transmit the one or more SRSs 345 via a first comb offset, of a set of resource elements, associated with the first SRS resource using the first antenna port, and via a second different comb offset (e.g., a second comb offset that is different from the first comb offset), of the set of resource elements, associated with the second SRS resource using the set of two antenna ports. For instance, a one-port SRS may be mapped to resource elements using a first comb offset and a two-port SRS may be mapped to resource elements using a second comb offset. An example of comb domain combining is given with reference to FIG. 5. The network entity 105-b may obtain (e.g., receive) the one or more SRSs via a first comb offset, of a set of resource elements, associated with the first SRS resource and the first antenna port, and via a second different comb offset, of the set of resource elements, associated with the second SRS resource and the set of two antenna ports.

In cyclic shift domain combining, the UE 115-b may transmit the one or more SRSs 345 via a symbol of a set of resource elements in accordance with a comb offset, the one or more SRSs being transmitted via the first SRS resource using the first antenna port and the second SRS resource using the set of two antenna ports, and the first antenna port and the set of two antenna ports may be mapped to the set of resource elements in accordance with a respective cyclic shift. For example, the one-port and two-port SRS resources may overlay in the comb domain and the time domain, and may be mapped to different cyclic shift indices in the cyclic shift domain. An example of cyclic shift domain combining is given with reference to FIG. 5. The network entity 105-b may obtain (e.g., receive) the one or more SRSs 345 via a symbol of a set of resource elements in accordance with a comb offset, the one or more SRSs being obtained via the first SRS resource, the first antenna port, the second SRS resource, and the set of two antenna ports, where the first antenna port and the set of two antenna ports are mapped to the set of resource elements in accordance with a respective cyclic shift.

In some approaches, a network entity may configure multiple SRS resources by radio resource control (RRC) signaling. For example, an SRS resource indicator (SRI) may be a field in downlink control information (DCI) that indicates which SRS resource is activated or associated with a PUSCH transmission. In some approaches, the SRI may indicate (e.g., may only point to) an individual SRS resource. For instance, an SRI=00 may indicate SRS resource A, SRI=01 may indicate SRS resource B, SRI=10 may indicate SRS resource C, and SRI=11 may indicate SRS resource D.

In some examples of the techniques described herein, the network entity 105-b may output (e.g., transmit) an indication of a combination of a first antenna port and a set of two antenna ports that includes a second antenna port and a third antenna port. The UE 115-b may receive the indication of a combination of a first antenna port and a set of two antenna ports that includes a second antenna port and a third antenna port. In some approaches, where a one-port SRS is combined with a two-port SRS to produce a three-port SRS, one or more SRI values may be utilized that point to a combination of multiple SRS resources. For example, SRI=000 may indicate SRS resource A, SRI=001 may indicate SRS resource B, SRI=010 may indicate SRS resource C, SRI=011 may indicate SRS resource D, SRI=100 may indicate a combination of SRS resources A and B, SRI=101 may indicate a combination of SRS resources A and C, SRI=110 may indicate a combination of SRS resources A and D, and SRI=111 may indicate a combination of SRS resources B and D (or may be reserved). While some examples of indicators and combinations are given, some examples may utilize other indicators or combinations.

In some approaches, the network entity 105-b may output (e.g., transmit) information indicating a set of combinations of the first antenna port and the set of two antenna ports. The UE 115-b may receive the information indicating the set of combinations of the first antenna port and the set of two antenna ports. The combination (e.g., the combination used for SRS transmission) may be included in the set of combinations of the first antenna port and the set of two antenna ports. For example, candidate combinations may be configured by RRC signaling and the SRI may indicate one of the candidate combinations.

As described herein, the UE 115-b may signal a capability (via RRC signaling, for example) to support a three-port SRS resource in some approaches. For instance, the information 340 may indicate a capability of the UE 115-b to support a three-port SRS resource. One or more aspects of UE 115-b capability may be signaled in one or more messages or using one or more indications. In some examples, the UE 115-b may indicate a capability to be configured with a four-port SRS resource (where three antenna ports are actually used) or a capability to be configured with a combination of a two-port SRS resource and a one-port SRS resource (across two TDM SRS resources, for example). In some examples, the capability may be signaled with a label (e.g., maxThreeSRS-Ports-PerResource). In some examples, the UE 115-b may signal an indication that the capability is applicable for codebook or non-codebook SRS uses. In some examples, the UE 115-b may signal an indication that the capability is applicable for periodic, semi-persistent, or aperiodic SRS resources. In some examples, the granularity of the capability may be per-band combination or per-feature set.

FIG. 4 shows an example of a first scenario 400-a and an example of a second scenario 400-b that support SRSs for uplink transmit antennas in accordance with one or more aspects of the present disclosure. The wireless communications system 100, the network architecture 200, or the wireless communications system 300 may operate in accordance with one or more aspects of the first scenario 400-a or the second scenario 400-b in some approaches. For example, a UE 115 or a network entity 105 described with reference to FIG. 1, the UE 115-a, CU 160-a, the DU 165-a, or the RU 170-a described with reference to FIG. 2, or the UE 115-b or the network entity 105-b described with reference to FIG. 3 may operate in accordance with one or more aspects of the first scenario 400-a or the second scenario 400-b.

A first set of resource elements 402 is illustrated in the first scenario 400-a. A comb 2 structure is utilized, where some resource elements 406 are associated with the comb 2 structure (e.g., a comb offset of 1). A first set of four ports 404 is also illustrated in the first scenario 400-a. The first set of four ports 404 includes Port 0 at a cyclic shift with 0 phase rotation, Port 1 with a cyclic shift at a n/2 phase rotation, Port 2 with a cyclic shift at a x phase rotation, and Port 3 with a cyclic shift at a 3π/2 phase rotation. In the example of the first scenario 400-a, a UE may be configured with four antenna ports, but may transmit SRS using three of the four antenna ports as described herein. For instance, Port 0, Port 1, and Port 2 may be utilized to transmit the SRS via the resource elements 406 with the comb structure, and Port 3 (or a last port in a set of ports) may be unused or muted. While an example of the resource elements 406 in accordance with a comb structure and of a first set of four ports 404 is given in the first scenario 400-a, other arrangements of resource elements, comb structures, ports, or cyclic shifts may be utilized in some examples.

In some approaches, ports may be mapped to cyclic shifts where a first port (e.g., Port 0) is assigned to 0 phase rotation. For instance, the first port may be mapped to a cyclic shift with 0 phase rotation. The mapping may continue in a counter-clockwise fashion (e.g., phase: 0, π/2, π, 3π/2). In some approaches, a network (e.g., a network entity) may configure an initial cyclic shift offset (e.g., init_CS) with phase=k*π/4 where k=0, 1, 2, . . . , 7 (or k*π/6 where k=0, 1, 2, . . . , 11, among other examples). With an initial cyclic shift offset, for example, the mapping may be expressed as: Port 0 mapped to a cyclic shift with phase 0+phase of init_CS, Port 1 mapped to a cyclic shift with phase π/2+phase of init_CS, Port 2 mapped to a cyclic shift with phase π+phase of init_CS, and Port 3 mapped to a cyclic shift with phase 3π/2+phase of init_CS. Accordingly, port mappings may be rotated by an initial cyclic shift offset. For instance, the mapping illustrated in the first scenario 400-a may be rotated by initial cyclic shift offset in some approaches (e.g., rotated by phase=k*π/4, where k=0, 1, 2, . . . , 7). As illustrated in the first scenario 400-a, eight potential cyclic shifts may be utilized for port mapping in some examples. Another quantity of cyclic shifts may be utilized in other examples. For instance, twelve potential cyclic shifts may be utilized for port mapping in the second scenario 400-b.

A second set of resource elements 412 is illustrated in the second scenario 400-b. A comb 4 structure is utilized, where some resource elements 416 are associated with the comb 4 structure (e.g., a comb offset of 0). A second set of four ports 414 is also illustrated in the second scenario 400-b. The second set of four ports 414 includes Port 0 at a cyclic shift with a π/3 phase rotation, Port 1 at a cyclic shift with a 5π/6 phase rotation, Port 2 at a 4π/3 phase rotation, and Port 3 at an 11π/6 phase rotation. In some approaches, the ports may be arranged (e.g., configured) with an initial cyclic shift offset of π/3. In the example of the second scenario 400-b, a UE may be configured with four antenna ports, but may transmit SRS using three of the four antenna ports as described herein. For instance, Port 0, Port 1, and Port 2 may be utilized to transmit the SRS via the resource elements 416 with the comb structure, and Port 3 (or a last port in a set of ports) may be unused. While an example of the resource elements 416 in accordance with a comb structure and of a second set of four ports 414 is given in the second scenario 400-b, other arrangements of resource elements, comb structures, ports, or cyclic shifts may be utilized in some examples.

FIG. 5 shows an example of time domain combining 500-a, an example of comb domain combining 500-b, and an example of cyclic shift domain combining 500-c that support SRSs for uplink transmit antennas in accordance with one or more aspects of the present disclosure. The wireless communications system 100, the network architecture 200, or the wireless communications system 300 may operate in accordance with one or more aspects of the time domain combining 500-a, the comb domain combining 500-b, or the cyclic shift domain combining 500-c, in some approaches. For example, a UE 115 or a network entity 105 described with reference to FIG. 1, the UE 115-a, CU 160-a, the DU 165-a, or the RU 170-a described with reference to FIG. 2, or the UE 115-b or the network entity 105-b described with reference to FIG. 3 may operate in accordance with one or more aspects of the time domain combining 500-a, the comb domain combining 500-b, or the cyclic shift domain combining 500-c.

The example of time domain combining 500-a is illustrated relative to frequency 510 (e.g., a frequency index, resource block index, or resource element index) and time 508 (e.g., an OFDM symbol index). In the example of time domain combining 500-a, a one-port SRS is transmitted via first resources 504 associated with a first symbol and a two-port SRS is transmitted via second resources 506 associated with a second symbol (using two cyclic shifts, for instance). Accordingly, the time domain combining 500-a may allow a three-port SRS transmission 502 using the first resources 504 and the second resources 506. In some approaches as described herein, a UE may transmit the two-port SRS with greater (e.g., double) power relative to the one-port SRS for measurement accuracy. Additionally, or alternatively, a UE may transmit the two-port SRS with the same power as the one-port SRS, and a network entity may boost the two-port SRS measurement relative to the one-port SRS measurement for measurement accuracy.

The example of comb domain combining 500-b is illustrated relative to frequency 520 (e.g., a frequency index, resource block index, or resource element index) and time 518 (e.g., an OFDM symbol index). In the example of comb domain combining 500-b, a one-port SRS is transmitted via first resources 514 associated with a first comb and a two-port SRS is transmitted via second resources 516 associated with a second comb (using two cyclic shifts, for instance). Accordingly, the comb domain combining 500-b may allow a three-port SRS transmission 512 using the first resources 514 and the second resources 516.

The example of cyclic shift domain combining 500-c is illustrated relative to frequency 530 (e.g., a frequency index, resource block index, or resource element index) and time 528 (e.g., an OFDM symbol index). In the example of cyclic shift domain combining 500-c, a one-port SRS is transmitted via first resources 524 associated with a first cyclic shift and a two-port SRS is transmitted via second resources 526 associated with a second cyclic shift and a third cyclic shift. Accordingly, the cyclic shift domain combining 500-c may allow a three-port SRS transmission 522 using the first resources 524 and the second resources 526.

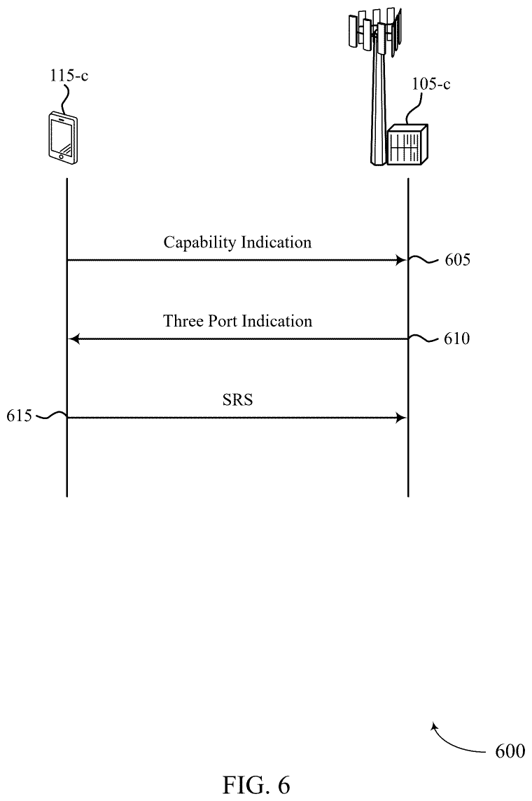

FIG. 6 shows an example of a process flow 600 that supports SRSs for uplink transmit antennas in accordance with one or more aspects of the present disclosure. A wireless communication system may include a UE 115-c and a network entity 105-c. The UE 115-c may be an example of the UEs 115 or the UE 115-b, and the network entity 105-c may be an example of the network entities 105, the CU 160-a, DU 165-a, the RU 170-a, or the network entity 105-b, as described herein.

In the following description of the process flow 600, the communications between the network entity 105-c and the UE 115-c may be transmitted in a different order than the example order shown, or the operations performed by the network entity 105-c and the UE 115-c may be performed in different orders or at different times. Some operations may be omitted from the process flow 600, or other operations may be added to the process flow 600. Further, although some operations or signaling may be shown to occur at different times for discussion purposes, these operations may actually occur at the same time or in overlapping time periods in some examples.

At 605, the UE 115-c may transmit a capability indication to the network entity 105-c. Transmitting the capability indication may be performed as described with reference to FIG. 3. For example, the UE 115-c may transmit a message indicating a capability of the UE 115-c to transmit SRS via three antenna ports.

At 610, the network entity 105-c may output (e.g., transmit) a three port indication to the UE 115-c. In some examples, outputting the three port indication may be performed as described with reference to FIG. 3. For example, the network entity 105-c may transmit a message (e.g., RRC message, DCI, SRI, among other examples) to the UE 115-c configuring or indicating the UE 115-c to transmit SRS using three antenna ports (with a four-port SRS configuration or a combination of a one-port SRS configuration and a two-port SRS configuration).

At 615, the UE 15-c may transmit SRS via three antenna ports using one or more SRS resources, where each of the SRS resources is associated with a quantity of one or more antenna ports other than three. In some examples, transmitting the SRS via the three antenna ports may be performed as described with reference to FIG. 3.

In some examples, the network entity 105-c may obtain (e.g., receive) the SRS. The network entity 105-c may utilize the SRS to measure one or more aspects of the wireless channel between the UE 115-c and the network entity 105-c. In some examples, the network entity 105-c may communicate with the UE 115-c or may configure or assign resources for communication based on the SRS.

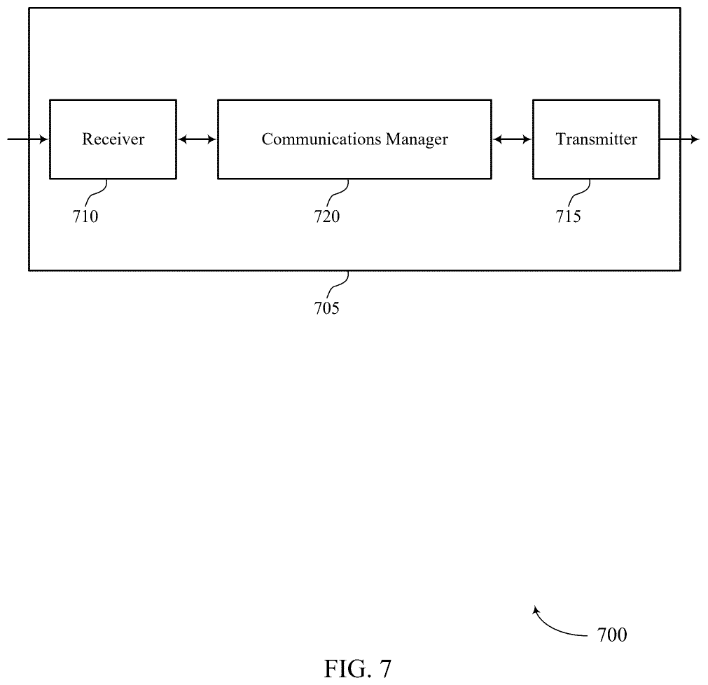

FIG. 7 shows a block diagram 700 of a device 705 that supports SRSs for uplink transmit antennas in accordance with one or more aspects of the present disclosure. The device 705 may be an example of aspects of a UE 115 as described herein. The device 705 may include a receiver 710, a transmitter 715, and a communications manager 720. The device 705, or one or more components of the device 705 (e.g., the receiver 710, the transmitter 715, and the communications manager 720), may include at least one processor, which may be coupled with at least one memory, to, individually or collectively, support or enable the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to SRSs for uplink transmit antennas). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to SRSs for uplink transmit antennas). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations thereof or various components thereof may be examples of means for performing various aspects of SRSs for uplink transmit antennas as described herein. For example, the communications manager 720, the receiver 710, the transmitter 715, or various combinations or components thereof may be capable of performing one or more of the functions described herein.

In some examples, the communications manager 720, the receiver 710, the transmitter 715, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 720, the receiver 710, the transmitter 715, or various combinations or components thereof may be implemented in code (e.g., as communications management software or firmware) executed by at least one processor. If implemented in code executed by at least one processor, the functions of the communications manager 720, the receiver 710, the transmitter 715, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

For example, the communications manager 720 is capable of, configured to, or operable to support a means for communicating information indicating three antenna ports for a transmission from the UE of one or more SRSs. The communications manager 720 is capable of, configured to, or operable to support a means for transmitting, based on the information indicating the three antenna ports, the one or more SRSs via the three antenna ports (e.g., the three antennas) using one or more SRS resources, each of the one or more SRS resources being associated with a quantity of one or more antenna ports other than three, where a power for SRS transmission is distributed over the three antenna ports.

By including or configuring the communications manager 720 in accordance with examples as described herein, the device 705 (e.g., at least one processor controlling or otherwise coupled with the receiver 710, the transmitter 715, the communications manager 720, or a combination thereof) may support techniques for reduced processing, reduced power consumption, or more efficient utilization of communication resources.

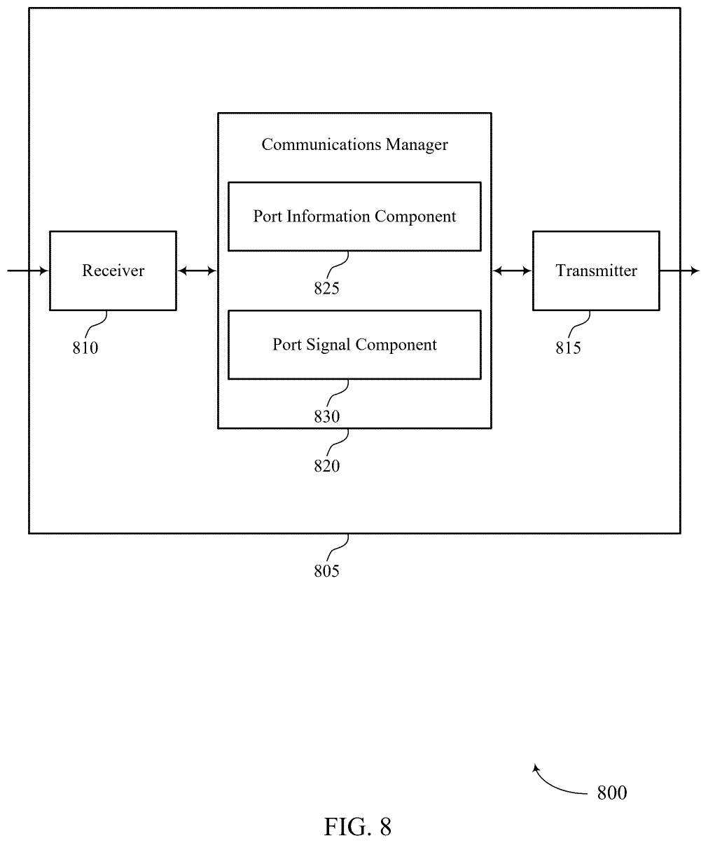

FIG. 8 shows a block diagram 800 of a device 805 that supports SRSs for uplink transmit antennas in accordance with one or more aspects of the present disclosure. The device 805 may be an example of aspects of a device 705 or a UE 115 as described herein. The device 805 may include a receiver 810, a transmitter 815, and a communications manager 820. The device 805, or one or more components of the device 805 (e.g., the receiver 810, the transmitter 815, and the communications manager 820), may include at least one processor, which may be coupled with at least one memory, to support the described techniques. Each of these components may be in communication with one another (e.g., via one or more buses).

The receiver 810 may provide a means for receiving information such as packets, user data, control information, or any combination thereof associated with various information channels (e.g., control channels, data channels, information channels related to SRSs for uplink transmit antennas). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to SRSs for uplink transmit antennas). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of SRSs for uplink transmit antennas as described herein. For example, the communications manager 820 may include a port information component 825 a port signal component 830, or any combination thereof. The communications manager 820 may be an example of aspects of a communications manager 720 as described herein. In some examples, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The port information component 825 is capable of, configured to, or operable to support a means for communicating information indicating three antenna ports for a transmission from the UE of one or more SRSs. The port signal component 830 is capable of, configured to, or operable to support a means for transmitting, based on the information indicating the three antenna ports, the one or more SRSs via the three antenna ports (e.g., three antennas) using one or more SRS resources, each of the one or more SRS resources being associated with a quantity of one or more antenna ports other than three, where a power for SRS transmission is distributed over the three antenna ports.

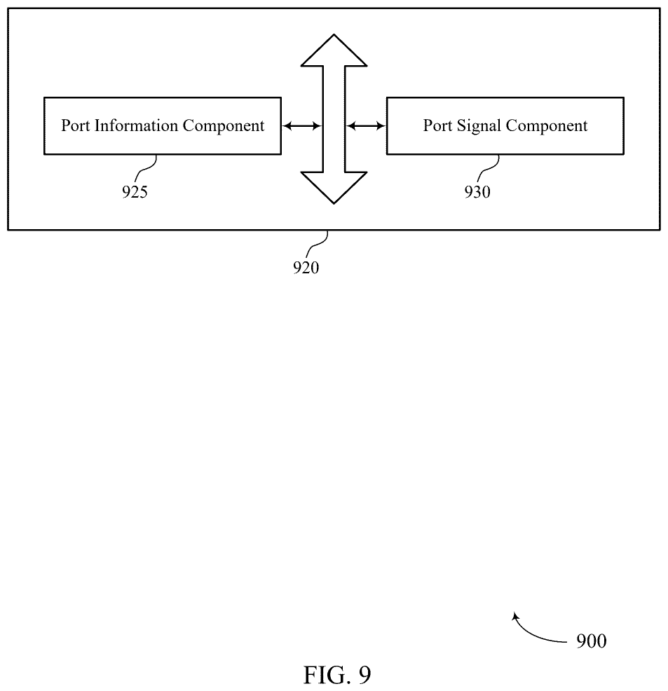

FIG. 9 shows a block diagram 900 of a communications manager 920 that supports SRSs for uplink transmit antennas in accordance with one or more aspects of the present disclosure. The communications manager 920 may be an example of aspects of a communications manager 720, a communications manager 820, or both, as described herein. The communications manager 920, or various components thereof, may be an example of means for performing various aspects of SRSs for uplink transmit antennas as described herein. For example, the communications manager 920 may include a port information component 925 a port signal component 930, or any combination thereof. Each of these components, or components or subcomponents thereof (e.g., one or more processors, one or more memories), may communicate, directly or indirectly, with one another (e.g., via one or more buses).

The port information component 925 is capable of, configured to, or operable to support a means for communicating information indicating three antenna ports for a transmission from the UE of one or more SRSs. The port signal component 930 is capable of, configured to, or operable to support a means for transmitting, based on the information indicating the three antenna ports, the one or more SRSs via the three antenna ports (e.g., three antennas) using one or more SRS resources, each of the one or more SRS resources being associated with a quantity of one or more antenna ports other than three, where a power for SRS transmission is distributed over the three antenna ports.

In some examples, to support transmitting the one or more SRSs, the port signal component 930 is capable of, configured to, or operable to support a means for transmitting the one or more SRSs via the three antenna ports included in a set of four antenna ports, where the one or more SRS resources are associated with the set of four antenna ports.

In some examples, each of the three antenna ports included in the set of four antenna ports is mapped to a set of resource elements in accordance with a respective cyclic shift. In some examples, one cyclic shift associated with one of the set of four antenna ports is unused or muted for the SRS transmission, and the one or more SRSs are transmitted via the set of resource elements and the three antenna ports.

In some examples, each of the three antenna ports is mapped to a comb offset in, or is mapped in accordance with a comb offset to, the set of resource elements with the respective cyclic shift. In some examples, the one or more SRSs are transmitted in accordance with the comb offset via the set of resource elements and the three antenna ports.

In some examples, a first antenna port of the three antenna ports is mapped to a first comb offset in, or is mapped in accordance with a comb offset to, the set of resource elements and a second antenna port of the three antenna ports is a mapped to a second different comb offset (e.g., a second comb offset that is different from a first comb offset) in the set of resource elements. In some examples, the one or more SRSs are transmitted in accordance with the first comb offset and the second different comb offset via the set of resource elements and the three antenna ports.

In some examples, communicating the information indicating the three antenna ports includes receiving a message indicating a configuration of four antenna ports. In some examples, the configuration is associated with use of the three antenna ports.

In some examples, the power for the SRS transmission is distributed evenly over the three antenna ports.

In some examples, to support transmitting the one or more SRSs, the port signal component 930 is capable of, configured to, or operable to support a means for transmitting the one or more SRSs via the three antenna ports including a first antenna port and a set of two antenna ports that includes a second antenna port and a third antenna port, where a first SRS resource of the one or more SRS resources is associated with the first antenna port and a second SRS resource of the one or more SRS resources is associated with the set of two antenna ports.

In some examples, the one or more SRSs are transmitted via a first symbol associated with the first SRS resource using the first antenna port, and via a second different symbol (e.g., a second symbol that is different from the first symbol) associated with the second SRS resource using the set of two antenna ports.

In some examples, the one or more SRSs are transmitted via the first symbol associated with the first SRS resource using the first antenna port with a first transmit power, and via the second different symbol associated with the second SRS resource using the set of two antenna ports and a second transmit power greater than the first transmit power.

In some examples, the second transmit power is approximately double the first transmit power.

In some examples, the one or more SRSs are transmitted via the first symbol associated with the first SRS resource using the first antenna port with a first transmit power, and via the second different symbol associated with the second SRS resource using the set of two antenna ports and a second transmit power that is approximately equal to the first transmit power.

In some examples, the one or more SRSs are transmitted via a first comb offset, of a set of resource elements, associated with the first SRS resource using the first antenna port, and via a second different comb offset (e.g., a second comb offset that is different from the first comb offset), of the set of resource elements, associated with the second SRS resource using the set of two antenna ports.

In some examples, the one or more SRSs are transmitted via a symbol of a set of resource elements in accordance with a comb offset, the one or more SRSs being transmitted via the first SRS resource using the first antenna port and the second SRS resource using the set of two antenna ports. In some examples, the first antenna port and the set of two antenna ports are mapped to the set of resource elements in accordance with a respective cyclic shift.

In some examples, communicating the information indicating the three antenna ports includes receiving an indication of a combination of a first antenna port and a set of two antenna ports that includes a second antenna port and a third antenna port.

In some examples, the port information component 925 is capable of, configured to, or operable to support a means for receiving information indicating a set of combinations of the first antenna port and the set of two antenna ports, where the combination is included in the set of combinations of the first antenna port and the set of two antenna ports.

In some examples, communicating the information indicating the three antenna ports includes transmitting a capability indication of the UE to transmit the SRSs via the three antenna ports or the three antennas.

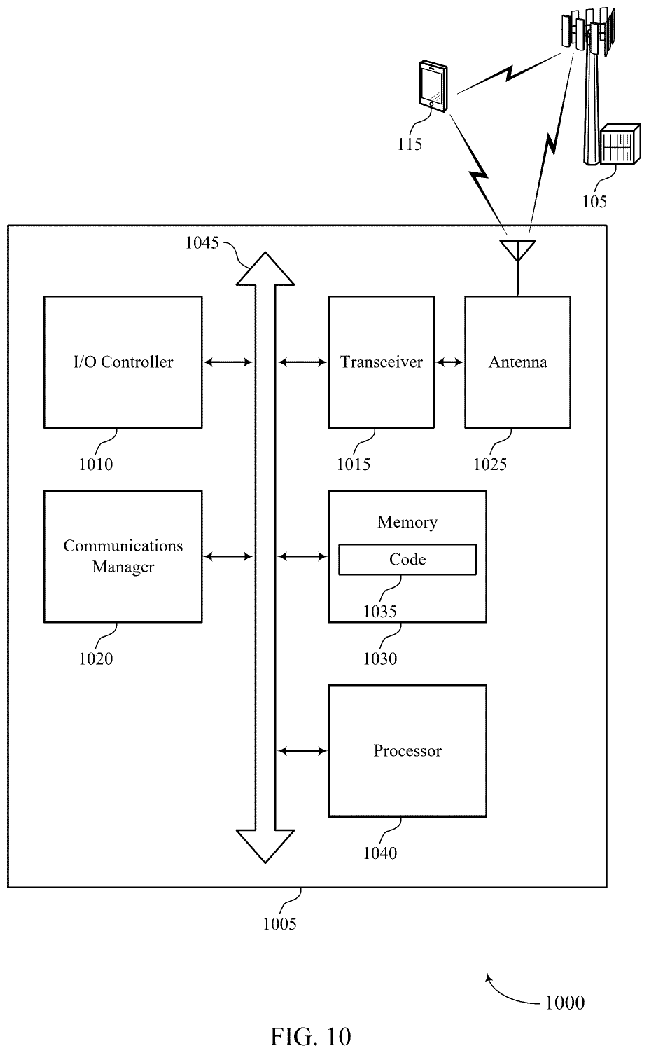

FIG. 10 shows a diagram of a system 1000 including a device 1005 that supports SRSs for uplink transmit antennas in accordance with one or more aspects of the present disclosure. The device 1005 may be an example of or include the components of a device 705, a device 805, or a UE 115 as described herein. The device 1005 may communicate (e.g., wirelessly) with one or more network entities 105, one or more UEs 115, or any combination thereof. The device 1005 may include components for bi-directional voice and data communications including components for transmitting and receiving communications, such as a communications manager 1020, an input/output (I/O) controller 1010, a transceiver 1015, an antenna 1025, at least one memory 1030, code 1035, and at least one processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. Additionally, or alternatively, the I/O controller 1010 may represent or interact with a modem, a keyboard, a mouse, a touchscreen, or a similar device. In some cases, the I/O controller 1010 may be implemented as part of one or more processors, such as the at least one processor 1040. In some cases, a user may interact with the device 1005 via the I/O controller 1010 or via hardware components controlled by the I/O controller 1010.

In some cases, the device 1005 may include a single antenna 1025. However, in some other cases, the device 1005 may have more than one antenna 1025, which may be capable of concurrently transmitting or receiving multiple wireless transmissions. The transceiver 1015 may communicate bi-directionally, via the one or more antennas 1025, wired, or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The at least one memory 1030 may include random access memory (RAM) and read-only memory (ROM). The at least one memory 1030 may store computer-readable, computer-executable code 1035 including instructions that, when executed by the at least one processor 1040, cause the device 1005 to perform various functions described herein. The code 1035 may be stored in a non-transitory computer-readable medium such as system memory or another type of memory. In some cases, the code 1035 may not be directly executable by the at least one processor 1040 but may cause a computer (e.g., when compiled and executed) to perform functions described herein. In some cases, the at least one memory 1030 may contain, among other things, a basic I/O system (BIOS) which may control basic hardware or software operation such as the interaction with peripheral components or devices.

The at least one processor 1040 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the at least one processor 1040 may be configured to operate a memory array using a memory controller. In some other cases, a memory controller may be integrated into the at least one processor 1040. The at least one processor 1040 may be configured to execute computer-readable instructions stored in a memory (e.g., the at least one memory 1030) to cause the device 1005 to perform various functions (e.g., functions or tasks supporting SRSs for uplink transmit antennas). For example, the device 1005 or a component of the device 1005 may include at least one processor 1040 and at least one memory 1030 coupled with or to the at least one processor 1040, the at least one processor 1040 and at least one memory 1030 configured to perform various functions described herein. In some examples, the at least one processor 1040 may include multiple processors and the at least one memory 1030 may include multiple memories. One or more of the multiple processors may be coupled with one or more of the multiple memories, which may, individually or collectively, be configured to perform various functions herein. In some examples, the at least one processor 1040 may be a component of a processing system, which may refer to a system (such as a series) of machines, circuitry (including, for example, one or both of processor circuitry (which may include the at least one processor 1040) and memory circuitry (which may include the at least one memory 1030)), or components, that receives or obtains inputs and processes the inputs to produce, generate, or obtain a set of outputs. The processing system may be configured to perform one or more of the functions described herein. For example, the at least one processor 1040 or a processing system including the at least one processor 1040 may be configured to, configurable to, or operable to cause the device 1005 to perform one or more of the functions described herein. Further, as described herein, being “configured to,” being “configurable to,” and being “operable to” may be used interchangeably and may be associated with a capability, when executing code stored in the at least one memory 1030 or otherwise, to perform one or more of the functions described herein.

For example, the communications manager 1020 is capable of, configured to, or operable to support a means for communicating information indicating three antenna ports for a transmission from the UE of one or more SRSs. The communications manager 1020 is capable of, configured to, or operable to support a means for transmitting, based on the information indicating the three antenna ports, the one or more SRSs via the three antenna ports using one or more SRS resources, each of the one or more SRS resources being associated with a quantity of one or more antenna ports other than three, where a power for SRS transmission is distributed over the three antenna ports. In some examples, the SRS transmission may be limited to three antennas.

By including or configuring the communications manager 1020 in accordance with examples as described herein, the device 1005 may support techniques for improved communication reliability, reduced latency, improved user experience related to reduced processing, reduced power consumption, more efficient utilization of communication resources, improved coordination between devices, longer battery life, or improved utilization of processing capability.

In some examples, the communications manager 1020 may be configured to perform various operations (e.g., receiving, monitoring, transmitting) using or otherwise in cooperation with the transceiver 1015, the one or more antennas 1025, or any combination thereof. Although the communications manager 1020 is illustrated as a separate component, in some examples, one or more functions described with reference to the communications manager 1020 may be supported by or performed by the at least one processor 1040, the at least one memory 1030, the code 1035, or any combination thereof. For example, the code 1035 may include instructions executable by the at least one processor 1040 to cause the device 1005 to perform various aspects of SRSs for uplink transmit antennas as described herein, or the at least one processor 1040 and the at least one memory 1030 may be otherwise configured to, individually or collectively, perform or support such operations.

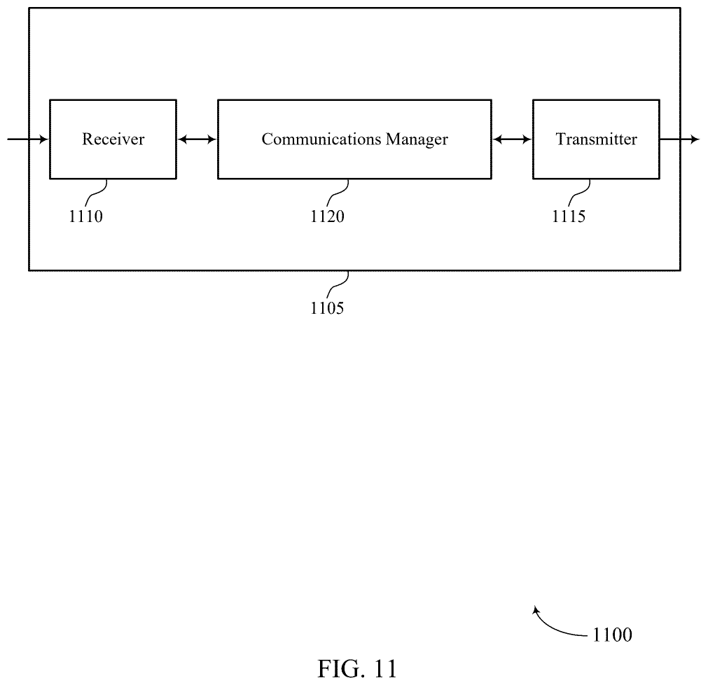

FIG. 11 shows a block diagram 1100 of a device 1105 that supports SRSs for uplink transmit antennas in accordance with one or more aspects of the present disclosure. The device 1105 may be an example of aspects of a network entity 105 as described herein. The device 1105 may include a receiver 1110, a transmitter 1115, and a communications manager 1120. The device 1105, or one or more components of the device 1105 (e.g., the receiver 1110, the transmitter 1115, and the communications manager 1120), may include at least one processor, which may be coupled with at least one memory, to, individually or collectively, support or enable the described techniques. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The communications manager 1120, the receiver 1110, the transmitter 1115, or various combinations thereof or various components thereof may be examples of means for performing various aspects of SRSs for uplink transmit antennas as described herein. For example, the communications manager 1120, the receiver 1110, the transmitter 1115, or various combinations or components thereof may be capable of performing one or more of the functions described herein.

In some examples, the communications manager 1120, the receiver 1110, the transmitter 1115, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1120, the receiver 1110, the transmitter 1115, or various combinations or components thereof may be implemented in code (e.g., as communications management software or firmware) executed by at least one processor. If implemented in code executed by at least one processor, the functions of the communications manager 1120, the receiver 1110, the transmitter 1115, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1120 may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications in accordance with examples as disclosed herein. For example, the communications manager 1120 is capable of, configured to, or operable to support a means for communicating information indicating three antenna ports for a transmission from a UE of one or more SRSs). The communications manager 1120 is capable of, configured to, or operable to support a means for obtaining, based on the information indicating the three antenna ports, the one or more SRSs via the three antenna ports using one or more SRS resources, each of the one or more SRS resources being associated with a quantity of one or more antenna ports other than three, where a power for SRS transmission is distributed over the three antenna ports. In some examples, the SRS transmission may be limited to three antennas.

By including or configuring the communications manager 1120 in accordance with examples as described herein, the device 1105 (e.g., at least one processor controlling or otherwise coupled with the receiver 1110, the transmitter 1115, the communications manager 1120, or a combination thereof) may support techniques for reduced processing, reduced power consumption, or more efficient utilization of communication resources.

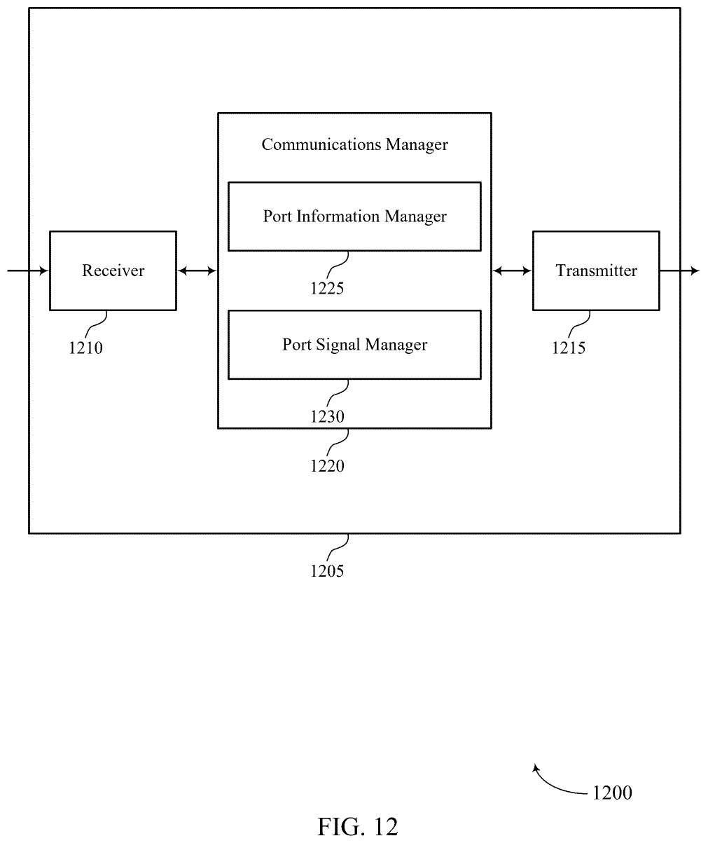

FIG. 12 shows a block diagram 1200 of a device 1205 that supports SRSs for uplink transmit antennas in accordance with one or more aspects of the present disclosure. The device 1205 may be an example of aspects of a device 1105 or a network entity 105 as described herein. The device 1205 may include a receiver 1210, a transmitter 1215, and a communications manager 1220. The device 1205, or one or more components of the device 1205 (e.g., the receiver 1210, the transmitter 1215, and the communications manager 1220), may include at least one processor, which may be coupled with at least one memory, to support the described techniques. Each of these components may be in communication with one another (e.g., via one or more buses).

The receiver 1210 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1205. In some examples, the receiver 1210 may support obtaining information by receiving signals via one or more antennas. Additionally, or alternatively, the receiver 1210 may support obtaining information by receiving signals via one or more wired (e.g., electrical, fiber optic) interfaces, wireless interfaces, or any combination thereof.

The transmitter 1215 may provide a means for outputting (e.g., transmitting, providing, conveying, sending) information generated by other components of the device 1205. For example, the transmitter 1215 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1215 may support outputting information by transmitting signals via one or more antennas. Additionally, or alternatively, the transmitter 1215 may support outputting information by transmitting signals via one or more wired (e.g., electrical, fiber optic) interfaces, wireless interfaces, or any combination thereof. In some examples, the transmitter 1215 and the receiver 1210 may be co-located in a transceiver, which may include or be coupled with a modem.

The device 1205, or various components thereof, may be an example of means for performing various aspects of SRSs for uplink transmit antennas as described herein. For example, the communications manager 1220 may include a port information manager 1225 a port signal manager 1230, or any combination thereof. The communications manager 1220 may be an example of aspects of a communications manager 1120 as described herein. In some examples, the communications manager 1220, or various components thereof, may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communications in accordance with examples as disclosed herein. The port information manager 1225 is capable of, configured to, or operable to support a means for communicating information indicating three antenna ports for a transmission from a UE of one or more SRSs. The port signal manager 1230 is capable of, configured to, or operable to support a means for obtaining, based on the information indicating the three antenna ports, the one or more SRSs via the three antenna ports using one or more SRS resources, each of the one or more SRS resources being associated with a quantity of one or more antenna ports other than three, where a power for SRS transmission is distributed over the three antenna ports. In some examples, the SRS transmission may be limited to three antennas.

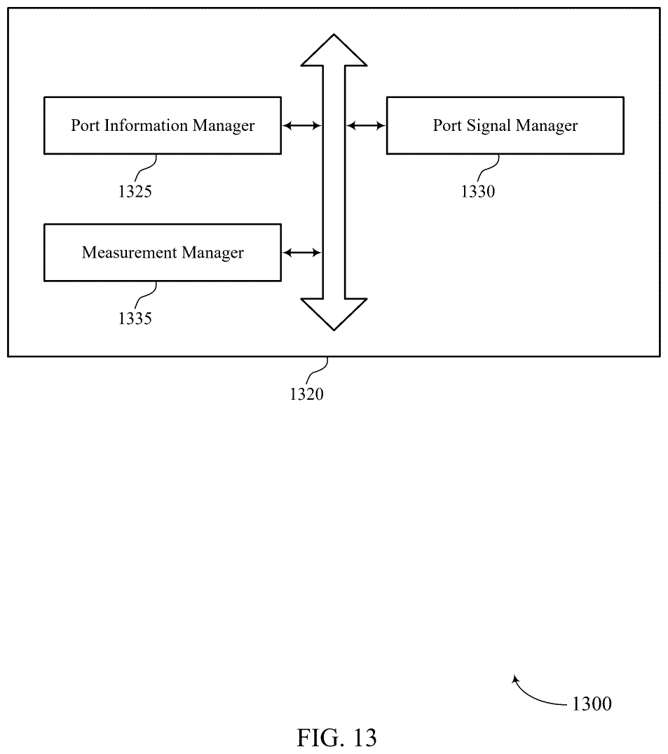

FIG. 13 shows a block diagram 1300 of a communications manager 1320 that supports SRSs for uplink transmit antennas in accordance with one or more aspects of the present disclosure. The communications manager 1320 may be an example of aspects of a communications manager 1120, a communications manager 1220, or both, as described herein. The communications manager 1320, or various components thereof, may be an example of means for performing various aspects of SRSs for uplink transmit antennas as described herein. For example, the communications manager 1320 may include a port information manager 1325, a port signal manager 1330, a measurement manager 1335, or any combination thereof. Each of these components, or components or subcomponents thereof (e.g., one or more processors, one or more memories), may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1320 may support wireless communications in accordance with examples as disclosed herein. The port information manager 1325 is capable of, configured to, or operable to support a means for communicating information indicating three antenna ports for a transmission from a UE of one or more SRSs. The port signal manager 1330 is capable of, configured to, or operable to support a means for obtaining, based on the information indicating the three antenna ports, the one or more SRSs via the three antenna ports using one or more SRS resources, each of the one or more SRS resources being associated with a quantity of one or more antenna ports other than three, where a power for SRS transmission is distributed over the three antenna ports. In some examples, the SRS transmission may be limited to three antennas.

In some examples, to support obtaining the one or more SRSs, the port signal manager 1330 is capable of, configured to, or operable to support a means for obtaining the one or more SRSs via the three antenna ports included in a set of four antenna ports, where the one or more SRS resources are associated with the set of four antenna ports.

In some examples, the one or more SRSs are obtained in accordance with a respective cyclic shift corresponding to each of the three antenna ports included in the set of four antenna ports. In some examples, one cyclic shift associated with one of the set of four antenna ports is unused or muted for the SRS transmission from the UE.

In some examples, the port information manager 1325 is capable of, configured to, or operable to support a means for outputting a message to a second UE for configuring the second UE with the one cyclic shift that is unused for the SRS transmission from the UE.

In some examples, the one or more SRSs are obtained in accordance with a comb offset in a set of resource elements corresponding to each of the three antenna ports.

In some examples, the one or more SRSs are obtained via a first antenna port of the three antenna ports in accordance with a first comb offset in a set of resource elements and via a second antenna port of the three antenna ports in accordance with a second different comb offset (e.g., a second comb offset that is different from the first comb offset) in the set of resource elements.

In some examples, communicating the information indicating the three antenna ports includes outputting a message indicating a configuration of four antenna ports. In some examples, the configuration is associated with use of the three antenna ports.

In some examples, the power for the SRS transmission is distributed evenly over the three antenna ports.

In some examples, to support obtaining the one or more SRSs, the port signal manager 1330 is capable of, configured to, or operable to support a means for obtaining the one or more SRSs via the three antenna ports including a first antenna port and a set of two antenna ports that includes a second antenna port and a third antenna port, where a first SRS resource of the one or more SRS resources is associated with the first antenna port and a second SRS resource of the one or more SRS resources is associated with the set of two antenna ports.

In some examples, the one or more SRSs are received via a first symbol associated with the first SRS resource and the first antenna port, and via a second different symbol (e.g., a second symbol that is different from the first symbol) associated with the second SRS resource and the set of two antenna ports.

In some examples, the one or more SRSs are received via the first symbol associated with the first SRS resource and the first antenna port with a first transmit power, and via the second different symbol associated with the second SRS resource, the set of two antenna ports, and a second transmit power greater than the first transmit power.

In some examples, the second transmit power is approximately double the first transmit power.

In some examples, the measurement manager 1335 is capable of, configured to, or operable to support a means for measuring at least one of the one or more SRSs that are obtained via the first symbol associated with the first SRS resource and the first antenna port to generate a first measurement. In some examples, the measurement manager 1335 is capable of, configured to, or operable to support a means for measuring at least one of the one or more SRSs that are obtained via the second different symbol associated with the second SRS resource and the set of two antenna ports to generate a second measurement. In some examples, the measurement manager 1335 is capable of, configured to, or operable to support a means for increasing the second measurement relative to the first measurement.

In some examples, the one or more SRSs are obtained via a first comb offset, of a set of resource elements, associated with the first SRS resource and the first antenna port, and via a second different comb offset (e.g., a second comb offset that is different from the first comb offset), of the set of resource elements, associated with the second SRS resource and the set of two antenna ports.

In some examples, the one or more SRSs are obtained via a symbol of a set of resource elements in accordance with a comb offset, the one or more SRSs being obtained via the first SRS resource, the first antenna port, the second SRS resource, and the set of two antenna ports. In some examples, the first antenna port and the set of two antenna ports are mapped to the set of resource elements in accordance with a respective cyclic shift.

In some examples, communicating the information indicating the three antenna ports includes outputting an indication of a combination of a first antenna port and a set of two antenna ports that includes a second antenna port and a third antenna port.

In some examples, the port information manager 1325 is capable of, configured to, or operable to support a means for outputting information indicating a set of combinations of the first antenna port and the set of two antenna ports, where the combination is included in the set of combinations of the first antenna port and the set of two antenna ports.

In some examples, communicating the information indicating the three antenna ports includes receiving a capability indication of the UE to transmit the SRSs via the three antenna ports or the three antennas.

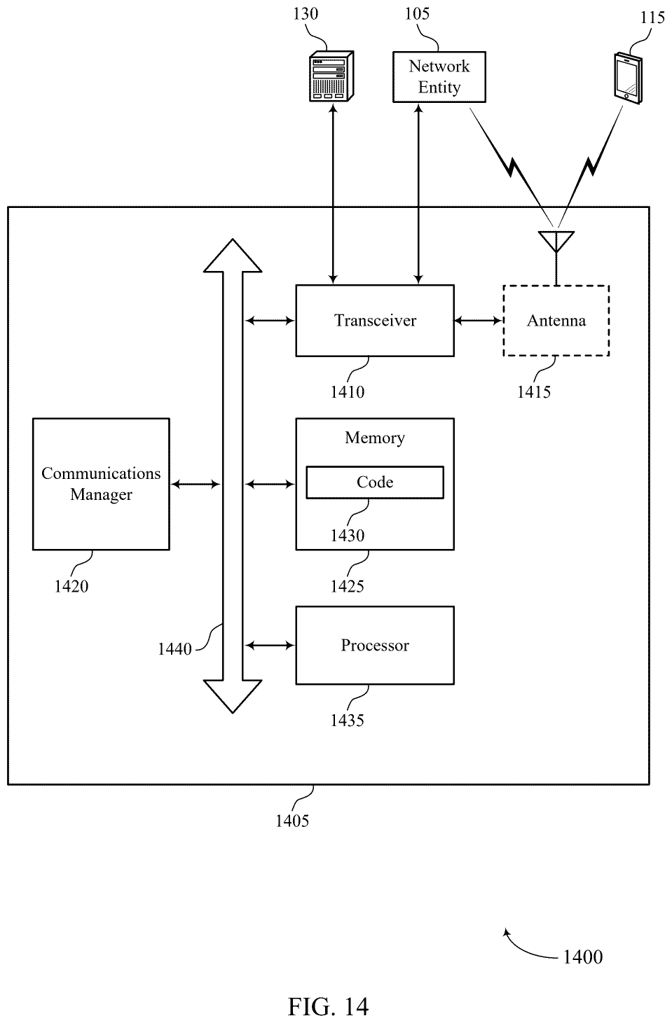

FIG. 14 shows a diagram of a system 1400 including a device 1405 that supports SRSs for uplink transmit antennas in accordance with one or more aspects of the present disclosure. The device 1405 may be an example of or include the components of a device 1105, a device 1205, or a network entity 105 as described herein. The device 1405 may communicate with one or more network entities 105, one or more UEs 115, or any combination thereof, which may include communications over one or more wired interfaces, over one or more wireless interfaces, or any combination thereof. The device 1405 may include components that support outputting and obtaining communications, such as a communications manager 1420, a transceiver 1410, an antenna 1415, at least one memory 1425, code 1430, and at least one processor 1435. These components may be in electronic communication or otherwise coupled (e.g., operatively, communicatively, functionally, electronically, electrically) via one or more buses (e.g., a bus 1440).

The transceiver 1410 may support bi-directional communications via wired links, wireless links, or both as described herein. In some examples, the transceiver 1410 may include a wired transceiver and may communicate bi-directionally with another wired transceiver. Additionally, or alternatively, in some examples, the transceiver 1410 may include a wireless transceiver and may communicate bi-directionally with another wireless transceiver. In some examples, the device 1405 may include one or more antennas 1415, which may be capable of transmitting or receiving wireless transmissions (e.g., concurrently). The transceiver 1410 may also include a modem to modulate signals, to provide the modulated signals for transmission (e.g., by one or more antennas 1415, by a wired transmitter), to receive modulated signals (e.g., from one or more antennas 1415, from a wired receiver), and to demodulate signals. In some implementations, the transceiver 1410 may include one or more interfaces, such as one or more interfaces coupled with the one or more antennas 1415 that are configured to support various receiving or obtaining operations, or one or more interfaces coupled with the one or more antennas 1415 that are configured to support various transmitting or outputting operations, or a combination thereof. In some implementations, the transceiver 1410 may include or be configured for coupling with one or more processors or one or more memory components that are operable to perform or support operations based on received or obtained information or signals, or to generate information or other signals for transmission or other outputting, or any combination thereof. In some implementations, the transceiver 1410, or the transceiver 1410 and the one or more antennas 1415, or the transceiver 1410 and the one or more antennas 1415 and one or more processors or one or more memory components (e.g., the at least one processor 1435, the at least one memory 1425, or both), may be included in a chip or chip assembly that is installed in the device 1405. In some examples, the transceiver 1410 may be operable to support communications via one or more communications links (e.g., a communication link 125, a backhaul communication link 120, a midhaul communication link 162, a fronthaul communication link 168).

The at least one memory 1425 may include RAM, ROM, or any combination thereof. The at least one memory 1425 may store computer-readable, computer-executable code 1430 including instructions that, when executed by one or more of the at least one processor 1435, cause the device 1405 to perform various functions described herein. The code 1430 may be stored in a non-transitory computer-readable medium such as system memory or another type of memory. In some cases, the code 1430 may not be directly executable by a processor of the at least one processor 1435 but may cause a computer (e.g., when compiled and executed) to perform functions described herein. In some cases, the at least one memory 1425 may contain, among other things, a BIOS which may control basic hardware or software operation such as the interaction with peripheral components or devices. In some examples, the at least one processor 1435 may include multiple processors and the at least one memory 1425 may include multiple memories. One or more of the multiple processors may be coupled with one or more of the multiple memories which may, individually or collectively, be configured to perform various functions herein (for example, as part of a processing system).

The at least one processor 1435 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the at least one processor 1435 may be configured to operate a memory array using a memory controller. In some other cases, a memory controller may be integrated into one or more of the at least one processor 1435. The at least one processor 1435 may be configured to execute computer-readable instructions stored in a memory (e.g., one or more of the at least one memory 1425) to cause the device 1405 to perform various functions (e.g., functions or tasks supporting SRSs for uplink transmit antennas). For example, the device 1405 or a component of the device 1405 may include at least one processor 1435 and at least one memory 1425 coupled with one or more of the at least one processor 1435, the at least one processor 1435 and the at least one memory 1425 configured to perform various functions described herein. The at least one processor 1435 may be an example of a cloud-computing platform (e.g., one or more physical nodes and supporting software such as operating systems, virtual machines, or container instances) that may host the functions (e.g., by executing code 1430) to perform the functions of the device 1405. The at least one processor 1435 may be any one or more suitable processors capable of executing scripts or instructions of one or more software programs stored in the device 1405 (such as within one or more of the at least one memory 1425). In some examples, the at least one processor 1435 may include multiple processors and the at least one memory 1425 may include multiple memories. One or more of the multiple processors may be coupled with one or more of the multiple memories, which may, individually or collectively, be configured to perform various functions herein. In some examples, the at least one processor 1435 may be a component of a processing system, which may refer to a system (such as a series) of machines, circuitry (including, for example, one or both of processor circuitry (which may include the at least one processor 1435) and memory circuitry (which may include the at least one memory 1425)), or components, that receives or obtains inputs and processes the inputs to produce, generate, or obtain a set of outputs. The processing system may be configured to perform one or more of the functions described herein. For example, the at least one processor 1435 or a processing system including the at least one processor 1435 may be configured to, configurable to, or operable to cause the device 1405 to perform one or more of the functions described herein. Further, as described herein, being “configured to,” being “configurable to,” and being “operable to” may be used interchangeably and may be associated with a capability, when executing code stored in the at least one memory 1425 or otherwise, to perform one or more of the functions described herein.

In some examples, a bus 1440 may support communications of (e.g., within) a protocol layer of a protocol stack. In some examples, a bus 1440 may support communications associated with a logical channel of a protocol stack (e.g., between protocol layers of a protocol stack), which may include communications performed within a component of the device 1405, or between different components of the device 1405 that may be co-located or located in different locations (e.g., where the device 1405 may refer to a system in which one or more of the communications manager 1420, the transceiver 1410, the at least one memory 1425, the code 1430, and the at least one processor 1435 may be located in one of the different components or divided between different components).

In some examples, the communications manager 1420 may manage aspects of communications with a core network 130 (e.g., via one or more wired or wireless backhaul links). For example, the communications manager 1420 may manage the transfer of data communications for client devices, such as one or more UEs 115. In some examples, the communications manager 1420 may manage communications with other network entities 105, and may include a controller or scheduler for controlling communications with UEs 115 in cooperation with other network entities 105. In some examples, the communications manager 1420 may support an X2 interface within an LTE/LTE-A wireless communications network technology to provide communication between network entities 105.

The communications manager 1420 may support wireless communications in accordance with examples as disclosed herein. For example, the communications manager 1420 is capable of, configured to, or operable to support a means for communicating information indicating three antenna ports for a transmission from a UE of one or more SRSs. The communications manager 1420 is capable of, configured to, or operable to support a means for obtaining, based on the information indicating the three antenna ports, the one or more SRSs via the three antenna ports using one or more SRS resources, each of the one or more SRS resources being associated with a quantity of one or more antenna ports other than three, where a power for SRS transmission is distributed over the three antenna ports. In some examples, the SRS transmission may be limited to three antennas.

By including or configuring the communications manager 1420 in accordance with examples as described herein, the device 1405 may support techniques for improved communication reliability, reduced latency, improved user experience related to reduced processing, reduced power consumption, more efficient utilization of communication resources, improved coordination between devices, longer battery life, or improved utilization of processing capability.

In some examples, the communications manager 1420 may be configured to perform various operations (e.g., receiving, obtaining, monitoring, outputting, transmitting) using or otherwise in cooperation with the transceiver 1410, the one or more antennas 1415 (e.g., where applicable), or any combination thereof. Although the communications manager 1420 is illustrated as a separate component, in some examples, one or more functions described with reference to the communications manager 1420 may be supported by or performed by the transceiver 1410, one or more of the at least one processor 1435, one or more of the at least one memory 1425, the code 1430, or any combination thereof (for example, by a processing system including at least a portion of the at least one processor 1435, the at least one memory 1425, the code 1430, or any combination thereof). For example, the code 1430 may include instructions executable by one or more of the at least one processor 1435 to cause the device 1405 to perform various aspects of SRSs for uplink transmit antennas as described herein, or the at least one processor 1435 and the at least one memory 1425 may be otherwise configured to, individually or collectively, perform or support such operations.

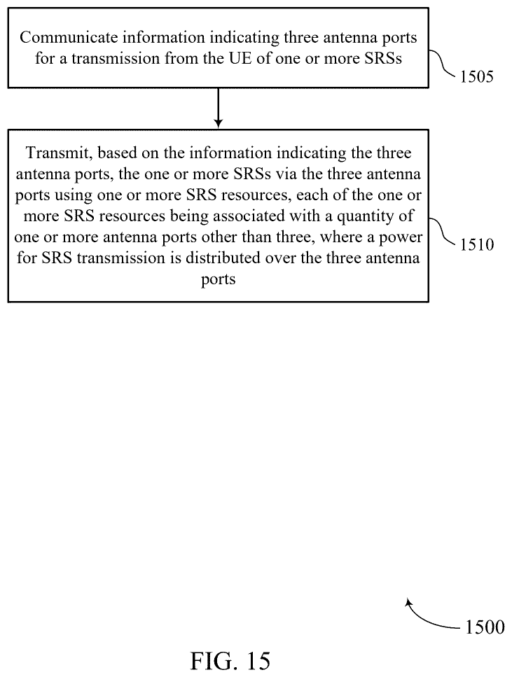

FIG. 15 shows a flowchart illustrating a method 1500 that supports SRSs for uplink transmit antennas in accordance with one or more aspects of the present disclosure. The operations of the method 1500 may be implemented by a UE or its components as described herein. For example, the operations of the method 1500 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1505, the method may include communicating information indicating three antenna ports for a transmission from the UE of one or more SRSs. The operations of block 1505 may be performed in accordance with examples as disclosed herein. In some examples, aspects of the operations of 1505 may be performed by a port information component 925 as described with reference to FIG. 9.

At 1510, the method may include transmitting, based on the information indicating the three antenna ports, the one or more SRSs via the three antenna ports using one or more SRS resources, each of the one or more SRS resources being associated with a quantity of one or more antenna ports other than three, where a power for SRS transmission is distributed over the three antenna ports. In some examples, the SRS transmission may be limited to a quantity of (e.g., three) ports or the UE may have a limited quantity of (e.g., three) antennas for SRS transmission or cellular (e.g., WWAN) communications. The operations of block 1510 may be performed in accordance with examples as disclosed herein. In some examples, aspects of the operations of 1510 may be performed by a port signal component 930 as described with reference to FIG. 9.

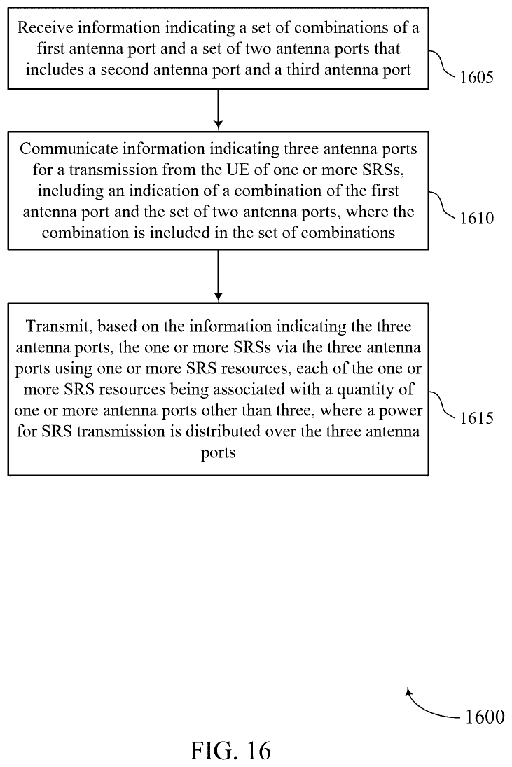

FIG. 16 shows a flowchart illustrating a method 1600 that supports SRSs for uplink transmit antennas in accordance with one or more aspects of the present disclosure. The operations of the method 1600 may be implemented by a UE or its components as described herein. For example, the operations of the method 1600 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1605, the method may include receiving information indicating a set of combinations of a first antenna port and a set of two antenna ports that includes a second antenna port and a third antenna port. The operations of block 1605 may be performed in accordance with examples as disclosed herein. In some examples, aspects of the operations of 1605 may be performed by a port information component 925 as described with reference to FIG. 9.

At 1610, the method may include communicating information indicating three antenna ports for a transmission from the UE of one or more SRSs, including an indication of a combination of the first antenna port and the set of two antenna ports, where the combination is included in the set of combinations. The operations of block 1610 may be performed in accordance with examples as disclosed herein. In some examples, aspects of the operations of 1610 may be performed by a port information component 925 as described with reference to FIG. 9.

At 1615, the method may include transmitting, based on the information indicating the three antenna ports, the one or more SRSs via the three antenna ports using one or more SRS resources, each of the one or more SRS resources being associated with a quantity of one or more antenna ports other than three, where a power for SRS transmission is distributed over the three antenna ports. In some examples, the SRS transmission may be limited to a quantity of (e.g., three) ports or the UE may have a limited quantity of (e.g., three) antennas for SRS transmission or cellular (e.g., WWAN) communications. The operations of block 1615 may be performed in accordance with examples as disclosed herein. In some examples, aspects of the operations of 1615 may be performed by a port signal component 930 as described with reference to FIG. 9.

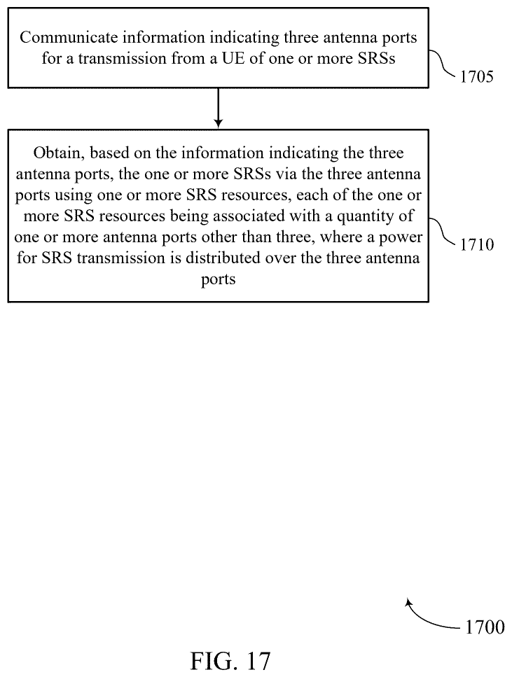

FIG. 17 shows a flowchart illustrating a method 1700 that supports SRSs for uplink transmit antennas in accordance with one or more aspects of the present disclosure. The operations of the method 1700 may be implemented by a network entity or its components as described herein. For example, the operations of the method 1700 may be performed by a network entity as described with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 1705, the method may include communicating information indicating three antenna ports for a transmission from a UE of one or more SRSs. The operations of block 1705 may be performed in accordance with examples as disclosed herein. In some examples, aspects of the operations of 1705 may be performed by a port information manager 1325 as described with reference to FIG. 13.

At 1710, the method may include obtaining, based on the information indicating the three antenna ports, the one or more SRSs via the three antenna ports using one or more SRS resources, each of the one or more SRS resources being associated with a quantity of one or more antenna ports other than three, where a power for SRS transmission is distributed over the three antenna ports. In some examples, the SRS transmission may be limited to a quantity of (e.g., three) ports or the UE may have a limited quantity of (e.g., three) antennas for SRS transmission or cellular (e.g., WWAN) communications. The operations of block 1710 may be performed in accordance with examples as disclosed herein. In some examples, aspects of the operations of 1710 may be performed by a port signal manager 1330 as described with reference to FIG. 13.

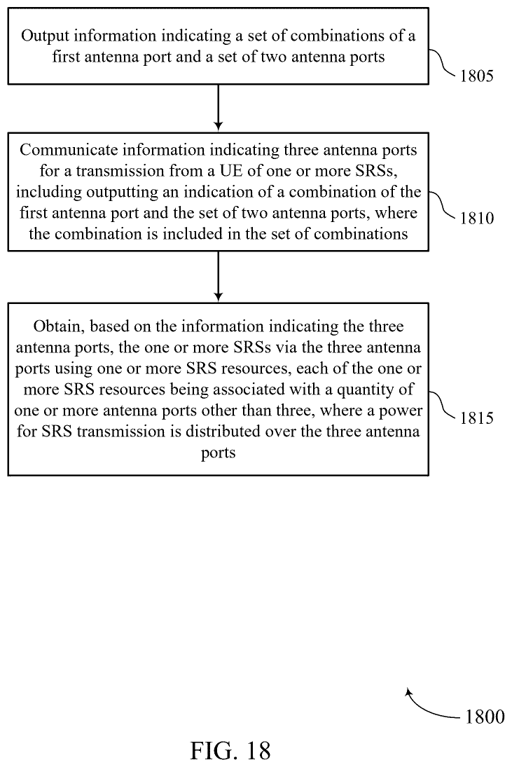

FIG. 18 shows a flowchart illustrating a method 1800 that supports SRSs for uplink transmit antennas in accordance with one or more aspects of the present disclosure. The operations of the method 1800 may be implemented by a network entity or its components as described herein. For example, the operations of the method 1800 may be performed by a network entity as described with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 1805, the method may include outputting information indicating a set of combinations of the first antenna port and the set of two antenna ports, where the combination is included in the set of combinations of the first antenna port and the set of two antenna ports. The operations of block 1805 may be performed in accordance with examples as disclosed herein. In some examples, aspects of the operations of 1805 may be performed by a port information manager 1325 as described with reference to FIG. 13.

At 1810, the method may include communicating information indicating three antenna ports for a transmission from a UE of one or more SRSs. The operations of block 1810 may be performed in accordance with examples as disclosed herein. In some examples, aspects of the operations of 1810 may be performed by a port information manager 1325 as described with reference to FIG. 13.

At 1815, the method may include obtaining, based on the information indicating the three antenna ports, the one or more SRSs via the three antenna ports using one or more SRS resources, each of the one or more SRS resources being associated with a quantity of one or more antenna ports other than three, where a power for SRS transmission is distributed over the three antenna ports. In some examples, the SRS transmission may be limited to a quantity of (e.g., three) ports or the UE may have a limited quantity of (e.g., three) antennas for SRS transmission or cellular (e.g., WWAN) communications. The operations of block 1815 may be performed in accordance with examples as disclosed herein. In some examples, aspects of the operations of 1815 may be performed by a port signal manager 1330 as described with reference to FIG. 13.

The following provides an overview of aspects of the present disclosure:
Aspect 1: A method for wireless communications at a UE, comprising: communicating information indicating three antenna ports for a transmission from the UE of one or more sounding reference signals (SRSs); and transmitting, based at least in part on the information indicating the three antenna ports, the one or more SRSs via the three antenna ports using one or more SRS resources, each of the one or more SRS resources being associated with a quantity of one or more antenna ports other than three, wherein a power for SRS transmission is distributed over the three antenna ports or the SRS transmission is limited to three antennas. Some of the techniques described herein may allow for devices to be implemented with three antennas (e.g., instead of more antennas) or may allow for the provision of three-layer MIMO transmissions, which may allow for improved communication performance without the additional expense of implementing one or more additional antennas, without the additional complexity of circuitry to support one or more additional antennas, or without the additional power consumption to operate one or more additional antennas (e.g., without following an exponential pattern for quantities of antennas or antenna ports). Additionally, or alternatively, some of the techniques described herein may allow for interoperability of a device with a wireless communications system that specifies a limitation on quantities of SRS ports that may be utilized (e.g., a wireless communications system that does not specify, provide, or configure, an SRS resource with three ports).
Aspect 2: The method of aspect 1, wherein transmitting the one or more SRSs comprises: transmitting the one or more SRSs via the three antenna ports included in a set of four antenna ports, wherein the one or more SRS resources are associated with the set of four antenna ports. Utilizing a four-port SRS resource for a three-port SRS transmission may leave one SRS port unused or muted (which may sacrifice the use of one SRS port to allow for a three-port SRS transmission in some cases, for instance), while allowing for increased performance over a two-port transmission, for example.
Aspect 3: The method of aspect 2, wherein each of the three antenna ports included in the set of four antenna ports is mapped to a set of resource elements in accordance with a respective cyclic shift, and one cyclic shift associated with one of the set of four antenna ports is unused or muted for the SRS transmission, and the one or more SRSs are transmitted via the set of resource elements and the three antenna ports. Leaving one cyclic shift unused or muted may allow for a three-port transmission while reducing or avoiding resource (e.g., power, computation, or bandwidth) consumption or reducing or avoiding interference associated with four-port or higher port transmissions, in some examples.
Aspect 4: The method of aspect 3, wherein each of the three antenna ports is mapped to a comb offset in the set of resource elements with the respective cyclic shift, and the one or more SRSs are transmitted in accordance with the comb offset via the set of resource elements and the three antenna ports.
Aspect 5: The method of aspect 3, wherein a first antenna port of the three antenna ports is mapped, in accordance with a first comb offset, to the set of resource elements and a second antenna port of the three antenna ports is mapped, in accordance with a second comb offset, to the set of resource elements, wherein the second comb offset is different from the first comb offset, and the one or more SRSs are transmitted in accordance with the first comb offset and the second comb offset via the set of resource elements and the three antenna ports.
Aspect 6: The method of any of aspects 1 through 5, wherein communicating the information indicating the three antenna ports comprises receiving a message indicating a configuration of four antenna ports, the configuration is associated with use of the three antenna ports. Providing a configuration for the use of three antenna ports may allow systems to configure devices for three port transmissions while a different quantity (e.g., 1, 2, 4, among other examples) of SRS resources are allocated.
Aspect 7: The method of any of aspects 1 through 6, wherein the power for the SRS transmission is distributed evenly over the three antenna ports.
Aspect 8: The method of aspect 1, wherein transmitting the one or more SRSs comprises: transmitting the one or more SRSs via the three antenna ports including a first antenna port and a set of two antenna ports that includes a second antenna port and a third antenna port, wherein a first SRS resource of the one or more SRS resources is associated with the first antenna port and a second SRS resource of the one or more SRS resources is associated with the set of two antenna ports.
Aspect 9: The method of aspect 8, wherein the one or more SRSs are transmitted via a first symbol associated with the first SRS resource using the first antenna port, and via a second symbol associated with the second SRS resource using the set of two antenna ports, wherein the second symbol is different from the first symbol.
Aspect 10: The method of aspect 9, wherein the one or more SRSs are transmitted via the first symbol associated with the first SRS resource using the first antenna port with a first transmit power, and via the second symbol associated with the second SRS resource using the set of two antenna ports and a second transmit power greater than the first transmit power.
Aspect 11: The method of aspect 10, wherein the second transmit power is approximately double the first transmit power.
Aspect 12: The method of aspect 9, wherein the one or more SRSs are transmitted via the first symbol associated with the first SRS resource using the first antenna port with a first transmit power, and via the second symbol associated with the second SRS resource using the set of two antenna ports and a second transmit power that is approximately equal to the first transmit power.
Aspect 13: The method of any of aspects 8 through 12, wherein the one or more SRSs are transmitted via a first comb offset, of a set of resource elements, associated with the first SRS resource using the first antenna port, and via a second comb offset, of the set of resource elements, associated with the second SRS resource using the set of two antenna ports, wherein the second comb offset is different from the first comb offset.
Aspect 14: The method of any of aspects 8 through 13, wherein the one or more SRSs are transmitted via a symbol of a set of resource elements in accordance with a comb offset, the one or more SRSs being transmitted via the first SRS resource using the first antenna port and the second SRS resource using the set of two antenna ports, and the first antenna port and the set of two antenna ports are mapped to the set of resource elements in accordance with a respective cyclic shift.
Aspect 15: The method of any of aspects 1 and 8 through 14, wherein communicating the information indicating the three antenna ports comprises receiving an indication of a combination of a first antenna port and a set of two antenna ports that includes a second antenna port and a third antenna port.
Aspect 16: The method of aspect 15, further comprising: receiving information indicating a set of combinations of the first antenna port and the set of two antenna ports, wherein the combination is included in the set of combinations of the first antenna port and the set of two antenna ports.
Aspect 17: The method of any of aspects 1 through 16, wherein communicating the information indicating the three antenna ports comprises transmitting a capability indication of the UE to transmit the SRSs via the three antenna ports or the three antennas.
Aspect 18: A method for wireless communications at a network entity, comprising: communicating information indicating three antenna ports for a transmission from a UE of one or more sounding reference signals (SRSs); and obtaining, based at least in part on the information indicating the three antenna ports, the one or more SRSs via the three antenna ports using one or more SRS resources, each of the one or more SRS resources being associated with a quantity of one or more antenna ports other than three, wherein a power for SRS transmission is distributed over the three antenna ports or the SRS transmission is limited to three antennas.
Aspect 19: The method of aspect 18, wherein obtaining the one or more SRSs comprises: obtaining the one or more SRSs via the three antenna ports included in a set of four antenna ports, wherein the one or more SRS resources are associated with the set of four antenna ports.
Aspect 20: The method of aspect 19, wherein the one or more SRSs are obtained in accordance with a respective cyclic shift corresponding to each of the three antenna ports included in the set of four antenna ports, and one cyclic shift associated with one of the set of four antenna ports is unused or muted for the SRS transmission from the UE.
Aspect 21: The method of aspect 20, further comprising: outputting a message to a second UE for configuring the second UE with the one cyclic shift that is unused for the SRS transmission from the UE.
Aspect 22: The method of any of aspects 20 through 21, wherein the one or more SRSs are obtained in accordance with a comb offset in a set of resource elements corresponding to each of the three antenna ports.
Aspect 23: The method of any of aspects 20 through 21, wherein the one or more SRSs are obtained via a first antenna port of the three antenna ports in accordance with a first comb offset in a set of resource elements and via a second antenna port of the three antenna ports in accordance with a second comb offset in the set of resource elements, wherein the second comb offset is different from the first comb offset.
Aspect 24: The method of any of aspects 18 through 23, wherein communicating the information indicating the three antenna ports comprises outputting a message indicating a configuration of four antenna ports, the configuration is associated with use of the three antenna ports.
Aspect 25: The method of any of aspects 18 through 24, wherein the power for the SRS transmission is distributed evenly over the three antenna ports.
Aspect 26: The method of aspect 18, wherein obtaining the one or more SRSs comprises: obtaining the one or more SRSs via the three antenna ports including a first antenna port and a set of two antenna ports that includes a second antenna port and a third antenna port, wherein a first SRS resource of the one or more SRS resources is associated with the first antenna port and a second SRS resource of the one or more SRS resources is associated with the set of two antenna ports.
Aspect 27: The method of aspect 26, wherein the one or more SRSs are received via a first symbol associated with the first SRS resource and the first antenna port, and via a second symbol associated with the second SRS resource and the set of two antenna ports, wherein the second symbol is different from the first symbol.
Aspect 28: The method of aspect 27, wherein the one or more SRSs are received via the first symbol associated with the first SRS resource and the first antenna port with a first transmit power, and via the second symbol associated with the second SRS resource, the set of two antenna ports, and a second transmit power greater than the first transmit power.
Aspect 29: The method of aspect 28, wherein the second transmit power is approximately double the first transmit power.
Aspect 30: The method of any of aspects 27 through 29, further comprising: measuring at least one of the one or more SRSs that are obtained via the first symbol associated with the first SRS resource and the first antenna port to generate a first measurement; measuring at least one of the one or more SRSs that are obtained via the second symbol associated with the second SRS resource and the set of two antenna ports to generate a second measurement; and increasing the second measurement relative to the first measurement.
Aspect 31: The method of any of aspects 26 through 30, wherein the one or more SRSs are obtained via a first comb offset, of a set of resource elements, associated with the first SRS resource and the first antenna port, and via a second comb offset, of the set of resource elements, associated with the second SRS resource and the set of two antenna ports, wherein the second comb offset is different from the first comb offset.
Aspect 32: The method of any of aspects 26 through 31, wherein the one or more SRSs are obtained via a symbol of a set of resource elements in accordance with a comb offset, the one or more SRSs being obtained via the first SRS resource, the first antenna port, the second SRS resource, and the set of two antenna ports, and the first antenna port and the set of two antenna ports are mapped to the set of resource elements in accordance with a respective cyclic shift.
Aspect 33: The method of any of aspects 18 and 26 through 32, wherein communicating the information indicating the three antenna ports comprises outputting an indication of a combination of a first antenna port and a set of two antenna ports that includes a second antenna port and a third antenna port.
Aspect 34: The method of aspect 33, further comprising: outputting information indicating a set of combinations of the first antenna port and the set of two antenna ports, wherein the combination is included in the set of combinations of the first antenna port and the set of two antenna ports.
Aspect 35: The method of any of aspects 18 through 34, wherein communicating the information indicating the three antenna ports comprises receiving a capability indication of the UE to transmit the SRSs via the three antenna ports or the three antennas.
Aspect 36: A UE comprising one or more memories storing processor-executable code, and one or more processors coupled with the one or more memories and individually or collectively operable to execute the code to cause the UE to perform a method of any of aspects 1 through 17.
Aspect 37: A UE comprising at least one means for performing a method of any of aspects 1 through 17.
Aspect 38: A non-transitory computer-readable medium storing code the code comprising instructions executable by one or more processors to perform a method of any of aspects 1 through 17.
Aspect 39: A network entity for wireless communications, comprising one or more memories storing processor-executable code, and one or more processors coupled with the one or more memories and individually or collectively operable to execute the code to cause the network entity to perform a method of any of aspects 18 through 35.
Aspect 40: A network entity for wireless communications, comprising at least one means for performing a method of any of aspects 18 through 35.
Aspect 41: A non-transitory computer-readable medium storing code for wireless communications, the code comprising instructions executable by one or more processors to perform a method of any of aspects 18 through 35.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
communicate information indicating three antenna ports for a transmission from the UE of one or more sounding reference signals (SRSs); and
transmit, based at least in part on the information indicating the three antenna ports, the one or more SRSs via the three antenna ports using one or more SRS resources, each of the one or more SRS resources being associated with a quantity of one or more antenna ports other than three, wherein a power for SRS transmission is distributed over the three antenna ports, and wherein the SRS transmission is limited to three antennas.

2. The UE of claim 1, wherein, to transmit the one or more SRSs, the one or more processors are individually or collectively operable to execute the code to cause the UE to:
transmit the one or more SRSs via the three antenna ports included in a set of four antenna ports, wherein the one or more SRS resources are associated with the set of four antenna ports.

3. The UE of claim 2, wherein:
each of the three antenna ports included in the set of four antenna ports is mapped to a set of resource elements in accordance with a respective cyclic shift, and
one cyclic shift associated with one of the set of four antenna ports is unused or muted for the SRS transmission, and the one or more SRSs are transmitted via the set of resource elements and the three antenna ports.

4. The UE of claim 3, wherein:
each of the three antenna ports is mapped, in accordance with a comb offset, to the set of resource elements with the respective cyclic shift, and
the one or more SRSs are transmitted in accordance with the comb offset via the set of resource elements and the three antenna ports.

5. The UE of claim 3, wherein:
a first antenna port of the three antenna ports is mapped, in accordance with a first comb offset, to the set of resource elements and a second antenna port of the three antenna ports is mapped, in accordance with a second comb offset, to the set of resource elements, wherein the second comb offset is different from the first comb offset, and
the one or more SRSs are transmitted in accordance with the first comb offset and the second comb offset via the set of resource elements and the three antenna ports.

6. The UE of claim 1, wherein communicating the information indicating the three antenna ports comprises receiving a message indicating a configuration of four antenna ports, wherein the configuration is associated with use of the three antenna ports.

7. The UE of claim 1, wherein the power for the SRS transmission is distributed evenly over the three antenna ports.

8. The UE of claim 1, wherein, to transmit the one or more SRSs, the one or more processors are individually or collectively operable to execute the code to cause the UE to:
transmit the one or more SRSs via the three antenna ports including a first antenna port and a set of two antenna ports that includes a second antenna port and a third antenna port, wherein a first SRS resource of the one or more SRS resources is associated with the first antenna port and a second SRS resource of the one or more SRS resources is associated with the set of two antenna ports.

9. The UE of claim 8, wherein the one or more SRSs are transmitted via a first symbol associated with the first SRS resource using the first antenna port, and via a second symbol associated with the second SRS resource using the set of two antenna ports, wherein the second symbol is different from the first symbol.

10. The UE of claim 9, wherein the one or more SRSs are transmitted via the first symbol associated with the first SRS resource using the first antenna port with a first transmit power, and via the second symbol associated with the second SRS resource using the set of two antenna ports and a second transmit power greater than the first transmit power.

11. The UE of claim 9, wherein the one or more SRSs are transmitted via the first symbol associated with the first SRS resource using the first antenna port with a first transmit power, and via the second symbol associated with the second SRS resource using the set of two antenna ports and a second transmit power that is approximately equal to the first transmit power.

12. The UE of claim 8, wherein:
the one or more SRSs are transmitted via a symbol of a set of resource elements in accordance with a comb offset, the one or more SRSs being transmitted via the first SRS resource using the first antenna port and the second SRS resource using the set of two antenna ports, and
the first antenna port and the set of two antenna ports are mapped to the set of resource elements in accordance with a respective cyclic shift.

13. The UE of claim 1, wherein communicating the information indicating the three antenna ports comprises receiving an indication of a combination of a first antenna port and a set of two antenna ports that includes a second antenna port and a third antenna port.

14. The UE of claim 1, wherein communicating the information indicating the three antenna ports comprises transmitting a capability indication of the UE to transmit the SRSs via the three antenna ports or the three antennas.

15. A network entity, comprising:
one or more memories storing processor-executable code; and
one or more processors coupled with the one or more memories and individually or collectively operable to execute the code to cause the network entity to:
communicate information indicating three antenna ports for a transmission from a user equipment (UE) of one or more sounding reference signals (SRSs); and
obtain, based at least in part on the information indicating the three antenna ports, the one or more SRSs via the three antenna ports using one or more SRS resources, each of the one or more SRS resources being associated with a quantity of one or more antenna ports other than three, wherein a power for SRS transmission is distributed over the three antenna ports, and wherein the SRS transmission is limited to three antennas.

16. The network entity of claim 15, wherein, to obtain the one or more SRSs, the one or more processors are individually or collectively operable to execute the code to cause the network entity to:
obtain the one or more SRSs via the three antenna ports included in a set of four antenna ports, wherein the one or more SRS resources are associated with the set of four antenna ports.

17. The network entity of claim 16, wherein:
the one or more SRSs are obtained in accordance with a respective cyclic shift corresponding to each of the three antenna ports included in the set of four antenna ports, and
one cyclic shift associated with one of the set of four antenna ports is unused or muted for the SRS transmission from the UE.

18. The network entity of claim 17, wherein the one or more SRSs are obtained in accordance with a comb offset in a set of resource elements corresponding to each of the three antenna ports.

19. The network entity of claim 17, wherein the one or more SRSs are obtained via a first antenna port of the three antenna ports in accordance with a first comb offset in a set of resource elements and via a second antenna port of the three antenna ports in accordance with a second comb offset in the set of resource elements, wherein the second comb offset is different from the first comb offset.

20. The network entity of claim 15, wherein communicating the information indicating the three antenna ports comprises outputting a message indicating a configuration of four antenna ports, wherein the configuration is associated with use of the three antenna ports.

21. The network entity of claim 15, wherein the power for the SRS transmission is distributed evenly over the three antenna ports.

22. The network entity of claim 15, wherein, to obtain the one or more SRSs, the one or more processors are individually or collectively operable to execute the code to cause the network entity to:
obtain the one or more SRSs via the three antenna ports including a first antenna port and a set of two antenna ports that includes a second antenna port and a third antenna port, wherein a first SRS resource of the one or more SRS resources is associated with the first antenna port and a second SRS resource of the one or more SRS resources is associated with the set of two antenna ports.

23. The network entity of claim 22, wherein the one or more SRSs are received via a first symbol associated with the first SRS resource and the first antenna port, and via a second symbol associated with the second SRS resource and the set of two antenna ports, wherein the second symbol is different from the first symbol.

24. The network entity of claim 23, wherein the one or more SRSs are received via the first symbol associated with the first SRS resource and the first antenna port with a first transmit power, and via the second symbol associated with the second SRS resource, the set of two antenna ports, and a second transmit power greater than the first transmit power.

25. The network entity of claim 23, wherein the one or more processors are individually or collectively further operable to execute the code to cause the network entity to:
measure at least one of the one or more SRSs that are obtained via the first symbol associated with the first SRS resource and the first antenna port to generate a first measurement;
measure at least one of the one or more SRSs that are obtained via the second symbol associated with the second SRS resource and the set of two antenna ports to generate a second measurement; and
increase the second measurement relative to the first measurement.

26. The network entity of claim 22, wherein the one or more SRSs are obtained via a first comb offset, of a set of resource elements, associated with the first SRS resource and the first antenna port, and via a second comb offset, of the set of resource elements, associated with the second SRS resource and the set of two antenna ports, wherein the second comb offset is different from the first comb offset.

27. The network entity of claim 22, wherein:
the one or more SRSs are obtained via a symbol of a set of resource elements in accordance with a comb offset, the one or more SRSs being obtained via the first SRS resource, the first antenna port, the second SRS resource, and the set of two antenna ports, and
the first antenna port and the set of two antenna ports are mapped to the set of resource elements in accordance with a respective cyclic shift.

28. The network entity of claim 15, wherein communicating the information indicating the three antenna ports comprises outputting an indication of a combination of a first antenna port and a set of two antenna ports that includes a second antenna port and a third antenna port.

29. The network entity of claim 28, wherein the one or more processors are individually or collectively further operable to execute the code to cause the network entity to:
output information indicating a set of combinations of the first antenna port and the set of two antenna ports, wherein the combination is included in the set of combinations of the first antenna port and the set of two antenna ports.

30. The network entity of claim 15, wherein communicating the information indicating the three antenna ports comprises receiving a capability indication of the UE to transmit the SRSs via the three antenna ports or the three antennas.

31. A method for wireless communications at a user equipment (UE), comprising:
communicating information indicating three antenna ports for a transmission from the UE of one or more sounding reference signals (SRSs); and
transmitting, based at least in part on the information indicating the three antenna ports, the one or more SRSs via the three antenna ports using one or more SRS resources, each of the one or more SRS resources being associated with a quantity of one or more antenna ports other than three, wherein a power for SRS transmission is distributed over the three antenna ports, and wherein the SRS transmission is limited to three antennas.

32. The method of claim 31, wherein transmitting the one or more SRSs comprises:
transmitting the one or more SRSs via the three antenna ports included in a set of four antenna ports, wherein the one or more SRS resources are associated with the set of four antenna ports.

33. The method of claim 32, wherein:
each of the three antenna ports included in the set of four antenna ports is mapped to a set of resource elements in accordance with a respective cyclic shift, and
one cyclic shift associated with one of the set of four antenna ports is unused or muted for the SRS transmission, and the one or more SRSs are transmitted via the set of resource elements and the three antenna ports.

34. The method of claim 31, wherein communicating the information indicating the three antenna ports comprises receiving a message indicating a configuration of four antenna ports, wherein the configuration is associated with use of the three antenna ports.

35. The method of claim 31, wherein the power for the SRS transmission is distributed evenly over the three antenna ports.

36. The method of claim 31, wherein communicating the information indicating the three antenna ports comprises transmitting a capability indication of the UE to transmit the SRSs via the three antenna ports or the three antennas.

37. A method for wireless communications at a network entity, comprising:
communicating information indicating three antenna ports for a transmission from a user equipment (UE) of one or more sounding reference signals (SRSs); and
obtaining, based at least in part on the information indicating the three antenna ports, the one or more SRSs via the three antenna ports using one or more SRS resources, each of the one or more SRS resources being associated with a quantity of one or more antenna ports other than three, wherein a power for SRS transmission is distributed over the three antenna ports, and wherein the SRS transmission is limited to three antennas.

38. The method of claim 37, wherein obtaining the one or more SRSs comprises:
obtaining the one or more SRSs via the three antenna ports included in a set of four antenna ports, wherein the one or more SRS resources are associated with the set of four antenna ports.

39. The method of claim 38, wherein:
the one or more SRSs are obtained in accordance with a respective cyclic shift corresponding to each of the three antenna ports included in the set of four antenna ports, and
one cyclic shift associated with one of the set of four antenna ports is unused or muted for the SRS transmission from the UE.

40. The method of claim 37, wherein communicating the information indicating the three antenna ports comprises outputting a message indicating a configuration of four antenna ports, wherein the configuration is associated with use of the three antenna ports.

41. The method of claim 37, wherein communicating the information indicating the three antenna ports comprises receiving a capability indication of the UE to transmit the SRSs via the three antenna ports or the three antennas.

42. A non-transitory computer-readable medium storing code for wireless communications, the code comprising instructions executable by one or more processors to:
communicate information indicating three antenna ports for a transmission from a user equipment (UE) of one or more sounding reference signals (SRSs); and
transmit, based at least in part on the information indicating the three antenna ports, the one or more SRSs via the three antenna ports using one or more SRS resources, each of the one or more SRS resources being associated with a quantity of one or more antenna ports other than three, wherein a power for SRS transmission is distributed over the three antenna ports, and wherein the SRS transmission is limited to three antennas.

43. The non-transitory computer-readable medium of claim 42, wherein the instructions to transmit the one or more SRSs are executable by the one or more processors to:
transmit the one or more SRSs via the three antenna ports included in a set of four antenna ports, wherein the one or more SRS resources are associated with the set of four antenna ports.

44. The non-transitory computer-readable medium of claim 43, wherein:
each of the three antenna ports included in the set of four antenna ports is mapped to a set of resource elements in accordance with a respective cyclic shift, and
one cyclic shift associated with one of the set of four antenna ports is unused or muted for the SRS transmission, and the one or more SRSs are transmitted via the set of resource elements and the three antenna ports.

45. The non-transitory computer-readable medium of claim 42, wherein the instructions to communicate the information indicating the three antenna ports are executable by the one or more processors to:
receive a message indicating a configuration of four antenna ports, wherein the configuration is associated with use of the three antenna ports.

46. The non-transitory computer-readable medium of claim 42, wherein the power for the SRS transmission is distributed evenly over the three antenna ports.

47. The non-transitory computer-readable medium of claim 42, wherein the instructions to communicate the information indicating the three antenna ports are executable by the one or more processors to:
transmit a capability indication of the UE to transmit the SRSs via the three antenna ports or the three antennas.

48. A non-transitory computer-readable medium storing code for wireless communications, the code comprising instructions executable by one or more processors to:
communicate information indicating three antenna ports for a transmission from a user equipment (UE) of one or more sounding reference signals (SRSs); and
obtain, based at least in part on the information indicating the three antenna ports, the one or more SRSs via the three antenna ports using one or more SRS resources, each of the one or more SRS resources being associated with a quantity of one or more antenna ports other than three, wherein a power for SRS transmission is distributed over the three antenna ports, and wherein the SRS transmission is limited to three antennas.

49. The non-transitory computer-readable medium of claim 48, wherein the instructions to obtain the one or more SRSs are executable by the one or more processors to:
obtain the one or more SRSs via the three antenna ports included in a set of four antenna ports, wherein the one or more SRS resources are associated with the set of four antenna ports.

50. The non-transitory computer-readable medium of claim 49, wherein:
the one or more SRSs are obtained in accordance with a respective cyclic shift corresponding to each of the three antenna ports included in the set of four antenna ports, and
one cyclic shift associated with one of the set of four antenna ports is unused or muted for the SRS transmission from the UE.

51. The non-transitory computer-readable medium of claim 48, wherein the instructions to communicate the information indicating the three antenna ports are executable by the one or more processors to:
output a message indicating a configuration of four antenna ports, wherein the configuration is associated with use of the three antenna ports.

52. The non-transitory computer-readable medium of claim 48, wherein the instructions to communicate the information indicating the three antenna ports are executable by the one or more processors to:
receive a capability indication of the UE to transmit the SRSs via the three antenna ports or the three antennas.
